(19) United States
(12) Patent Application Publication
(10) Pub. No.: US 2016/0005361 A1
(43) Pub. Date: Jan. 7, 2016

(54) DISPLAY DEVICE

(71) Applicant: Pixtronix, Inc., San Diego, CA (US)

(72) Inventors: Kenta Kajiyama, Yotsukaido (JP); Katsumi Matsumoto, Mobara (JP); Hideki Nakagawa, Mobara (JP); Takahide Kuranaga, Mobara (JP); Takeomi Morita, Mobara (JP)

(73) Assignee: Pixtronix, Inc., San Diego, CA (US)

(21) Appl. No.: 14/766,714

(22) PCT Filed: Mar. 21, 2014
(86) PCT No.: PCT/US14/31470

§ 371 Date: Aug. 7, 2015

(30) Foreign Application Priority Data
Mar. 22, 2013 (JP) 2013-060071

(51) Int. Cl. G09G 3/34; G02B 26/02; H04N 9/30

(52) U.S. Cl. CPC G09G 3/3406; H04N 9/30; G02B 26/02; G09G 2310/0254; G09G 2310/0262

(57) ABSTRACT

[PROBLEM] To provide substantially the same voltage to a shutter electrode and a pair of control electrodes, and to prevent degradation of the mechanical shutter, during a discharge period in a movable shutter system in an image display device. [RESOLUTION MEANS] A plurality of pixels are provided each having a mechanical shutter, wherein the mechanical shutter comprises a shutter electrode and first and second control electrodes provided in a pair with respect to the shutter electrode; and the display device displays images by electrically controlling a position of the shutter electrode; wherein the display device comprises a discharge period and a display period, and in the display period, a low voltage drive voltage of VL, or a high voltage drive voltage of VH with a voltage higher than the low voltage drive voltage of VL, is supplied to the shutter electrode, the first control electrode, and the second control electrode, and |Vs−Vp1|≦(VH−VL)/10, and |Vs−Vp2|≦(VH−VL)/10, where Vs is a voltage supplied to the shutter electrode, Vp1 is a voltage supplied to the first control electrode, and Vp2 is a voltage supplied to the second control electrode.

### RELATED APPLICATIONS

The present application for Patent claims priority to Japanese Application No. 2013-060071, entitled “Method of Improving Reliability,” filed Mar. 22, 2013, and assigned to the assignee hereof and hereby expressly incorporated by reference herein.

### TECHNICAL FIELD

The present invention relates to a display device and more particularly to an effective technique applicable to a pixel circuit of an image display device that performs image display to electrically control a position of a mechanical shutter.

### BACKGROUND TECHNOLOGY

An image display device (hereafter referred to as an image display device with a movable shutter system) that displays an image by electrically controlling positions of mechanical shutters (hereafter referred to as MEMS shutters) and a drive method thereof is disclosed for example in the Patent Document 1 described below.

This image display device of the movable shutter system has a plurality of pixels that each have a MEMS shutter, and a light source part that irradiates red (R), green (G), and blue (B) light, respectively.

Image is displayed by moving these MEMS shutters by electrostatic force, emitting light irradiated from the light source part and propagated inside a light guide plate when the MEMS shutters are open (i.e., aligned with an opening formed in the light guide plate), and blocking the light irradiated from the light source part and propagated inside the light guide plate when the MEMS shutters are closed (i.e., not aligned with the opening formed in the light guide plate).

### PRIOR TECHNOLOGY DOCUMENT

### Patent Document

[Patent Document 1] US No. 2011/0164067

### SUMMARY OF THE INVENTION

### Problems to be Solved by the Invention

Shortened lifespan of the image display device due to control failures of the MEMS shutters in the movable shutter system is found to be caused by an adhesive force generated between a shutter electrode and a pair of control electrodes.

This will be explained using FIG. 18. FIG. 18 is a schematic diagram of a shutter electrode 208 provided for each pixel and one control electrode 209 from the pair of control electrodes in the image display device of the movable shutter system. An insulating film 50 made of aluminum or silicon nitride is provided between and around the electrodes.

Here, FIG. 18(a) is a view of the shutter electrode 208 being pulled up electrostatically by the control electrode 209, and 25 V, for example, are applied between the electrodes. At this time, a predetermined electric field occurs in the insulating film 50 interposed between the electrodes, and a leakage current due to a Poole-Frankel or Fowler-Nordheim injection current occurs.

Here, which current injection mechanism becomes the main one is determined by film quality, the electric field, temperature, and the like. For example, when a low voltage (hereafter referred to as L-level) is applied to the shutter electrode 208 and a high voltage (hereafter referred to as H-level) is applied to the control electrode 209, the generated leakage current is defined as an electron injection from the shutter electrode 208 to the control electrode 209, but here, there is a contact interface on the insulating film 50 between the electrodes, and it needs to be noted that a great number of electron trapping levels are present in this portion.

There are few effects due to electron trapping because electron emission from the insulating layer 50 on the shutter electrode 208 side concentrates on a minute convex portion of the insulating layer, but because injected electrons are dispersed over a wide range on an interface of the insulating layer 50 on the control electrode 209 side, a great number of electrons are trapped in the electron trapping levels. FIG. 18(b) is a diagram that illustrates this state.

Furthermore, FIG. 18(c) is a diagram illustrating a state that follows where voltage application to the electrodes has ceased. Even after voltage application has ceased, electrons once trapped remain for a comparatively long time on the interface of the insulating layer 50. It is thought that because this remaining charge reduces a voltage of a positive electrode even when attempting to close both electrodes by continuing to apply a low voltage of the L-level to the shutter electrode 208 and a high voltage of the H-level to the control electrode 209, control of the shutter by electrostatic force becomes unstable, leading to the decrease in life of the MEMS shutters or a decrease in life of a display product.

For solving these problem points described above, a ground voltage of the L-level and a voltage of 25 V of the H-level are applied alternately to the shutter electrode 208 to drive the shutter electrode 208.

This drive method will be called a polarity reverse drive method, a state of driving the shutter electrode 208 by applying the voltage of the GND will be defined as a “state of negative polarity,” and a state of driving the shutter electrode 208 by applying the voltage of 25 V will be defined as a “state of positive polarity.”

However, the inventor of the present application finds that a balance of the voltage breaks down between the “state of positive polarity” and the “state of negative polarity” even when driving under the polarity reverse drive method described above, an electric charge accumulates in the shutter electrode or the insulating layer of the pair of control electrodes, and the MEMS shutters degrade, reducing lifespan of the MEMS shutters.

FIG. 17 is a diagram illustrating voltage changes of the shutter electrode 208, an OPEN electrode, and a CLOSE electrode relating to an update period, a shutter movement period, and an emission period in the conventional image display device of the movable shutter system.

Note that in FIG. 17, one electrode from the pair of control electrodes is described as the OPEN electrode and the other electrode from the pair of control electrodes is described as the CLOSE electrode. Moreover, in FIG. 17, the voltage level of the shutter electrode is illustrated as “Shutter,” the voltage level of the OPEN electrode as “OPEN,” and the voltage level of the CLOSE electrode as “CLOSE.”

In the conventional image display device of the movable shutter system, during an update period of the state of positive polarity and an update period of the state of negative polarity, the shutter electrode, the voltages of the OPEN electrode and the CLOSE electrode, the voltage between the shutter electrode 208 and the CLOSE electrode, and the voltage between the shutter electrode 208 and the OPEN electrode are as indicated in Table 3.

Note that in Table 3, the voltage of the shutter electrode 208 is described as “Shutter potential,” the voltage of the OPEN electrode as “OPEN potential,” the voltage of the CLOSE electrode as “CLOSE potential,” the voltage between the shutter electrode 208 and the OPEN electrode as “Voltage between shutter and OPEN,” and the voltage between the shutter electrode 208 and the CLOSE electrode as “Voltage between shutter and CLOSE.”

In the conventional image display device of the movable shutter system, during an update period of the state of positive polarity, the voltage of the shutter electrode 208 is 25 V (i.e., the H-level); the voltages of the OPEN electrode and the CLOSE electrode are 0 V (i.e., the low level); and the voltage between the shutter electrode 208 and the CLOSE electrode and the voltage between the shutter electrode 208 and the OPEN electrode are 25 V.

Furthermore, during the update period of the state of negative polarity, the low level voltage of the shutter electrode 208 is 0 V; the low level voltages of the OPEN electrodes and the CLOSE electrode are 0 V; and the voltage between the shutter electrode 208 and the CLOSE electrode and the voltage between the shutter electrode 208 and the OPEN electrode are 0 V.

In this manner, during the update period, even when driving with the polarity reverse drive method, the balance between the voltages in the “state of positive polarity” and the “state of negative polarity” breaks down, the electrical charge accumulates in the shutter electrode or the insulating layer of the pair of control electrodes, the MEMS shutters degrade, and thus, the lifespan of the MEMS shutters is shortened.

The present invention is made based on the information described above, and an object of the present invention is to provide a technique that can supply a substantially equal voltage to a shutter electrode and a pair of control electrodes during a discharge period in an image display device with a movable shutter system and prevent degradation of a mechanical shutter.

The object of the present invention described above, as well as other objects of the present invention and new features thereof, will be clarified by the contents of the present specification and the attached drawings.

### Means for Solving the Problems

A brief description of a summary of representative inventions from among those disclosed in the present application is as described below.

(1) A plurality of pixels each having a mechanical shutter where the mechanical shutter is provided with a shutter electrode and first and second control electrodes provided in a pair with respect to the shutter electrode, and a display device displays images by electrically controlling a position of the shutter electrode. The display device is provided with a discharge period and a display period after the discharge period. Vp1=Vp2=Vs is satisfied where, Vs is a voltage supplied to the shutter electrode, Vp1 is a voltage supplied to the first control electrode, and Vp2 is a voltage supplied to the second control electrode.

(2) In (1), in the display period, a low voltage drive voltage of VL, or a high voltage drive voltage of VH with a voltage higher than the low voltage drive voltage of VL, is supplied to the shutter electrode, the first control electrode, and the second control electrode, and Vs=(VH−VL)/2, Vs=VH, or Vs=VL.

(3) A plurality of pixels each having a mechanical shutter, where the mechanical shutter is provided with a shutter electrode and first and second control electrodes provided in a pair with respect to the shutter electrode, and a display device that displays images by electrically controlling a position of the shutter electrode. The display device is provided with a discharge period and a display period after the discharge period. In the display period, a low voltage of VL, or a high voltage of VH with a voltage higher than the low voltage of VL, is supplied to the shutter electrode, the first control electrode, and the second control electrode. During the discharge period, |Vs−Vp1|≦(VH−VL)/10, and |Vs−Vp2|≦(VH−VL)/10, where Vs is a voltage supplied to the shutter electrode, Vp1 is a voltage supplied to the first control electrode, and Vp2 is a voltage supplied to the second control electrode.

(4) In (3), Vs is a voltage of (VH+VL)/2.

(5) A plurality of pixels each having a mechanical shutter where the mechanical shutter is provided with a shutter electrode and first and second control electrodes provided in a pair with respect to the shutter electrode, and a display device that displays images by electrically controlling a position of the shutter electrode. The display device is provided with a discharge period and a display period after the discharge period, and when, during the discharge period, a voltage Vs is supplied to the shutter electrode, an average value of the voltage supplied to the first control electrode and an average value of the voltage supplied to the second control electrode are the same voltage as Vs.

(6) A plurality of pixels each having a mechanical shutter where the mechanical shutter is provided with a shutter electrode and first and second control electrodes provided in a pair with respect to the shutter electrode, and a display device that displays images by electrically controlling a position of the shutter electrode. The display device is provided with a discharge period and a display period after the discharge period, and during the discharge period (Vp1+Vp2)/2=Vs, where Vs is a voltage supplied to the shutter electrode, Vp1 is a voltage supplied to the first control electrode, and Vp2 is a voltage supplied to the second control electrode.

(7) A plurality of pixels each having a mechanical shutter where the mechanical shutter is provided with a shutter electrode and first and second control electrodes provided in a pair with respect to the shutter electrode, and a display device that displays images by electrically controlling a position of the shutter electrode. The display device is provided with a discharge period and a display period after the discharge period, and during the discharge period |Vs−Vp1|≦Vpo and |Vs−Vp2|≦Vpo, where Vs is a voltage supplied to the shutter electrode, Vp1 is a voltage supplied to the first control electrode, Vp2 is a voltage supplied to the second control electrode, and Vpo is a pull-out voltage.

(8) In any of the examples (5) through (7) discussed above, in the display period, a low voltage drive voltage of VL, or a high voltage drive voltage of VH with a voltage higher than the low voltage drive voltage of VL, can be supplied to the shutter electrode, the first control electrode, and the second control electrode, and Vs can be a voltage equal to (VH+VL)/2.

(9) In any of the examples (3) through (8) discussed above, a plurality of video lines that input image signal voltage to each pixel, a plurality of scan lines that input scanning voltage to each pixel, a first power supply line that supplies a first power supply voltage, a second power supply line that supplies a second power supply voltage, a shutter voltage line that supplies a shutter control voltage, and an update voltage line that supplies an update voltage can be provided. Each pixel has a pixel circuit that electrically controls a position of the mechanical shutter. The pixel circuit is provided with an input transistor where a source of the input transistor is connected to a corresponding video line from among the plurality of video lines, and a gate is connected to a corresponding scan line from among the plurality of scan lines; a storage capacitor that stores voltage output by the input transistor and has another end connected to the first power supply line while one end is connected to the drain of the input transistor; a transfer transistor where a gate is connected to the update voltage line and a source is connected to a drain of the input transistor; a first CMOS inverter circuit connected between the first power supply line and the second power supply line with the input terminal thereof connected to a drain of the transfer transistor; and a second CMOS inverter circuit connected between the first power supply line and the second power supply line with the input terminal thereof connected to an output terminal of the first CMOS inverter circuit. A first transistor connected between an input terminal of the first CMOS inverter circuit and an output terminal of the second inverter circuit with a gate thereof connected to the update voltage line. The first control electrode is connected to an output terminal of the first CMOS inverter circuit, the second control electrode is connected to an output terminal of the second CMOS inverter circuit, and the shutter electrode is connected to the shutter voltage line.

(10) A plurality of pixels each having a mechanical shutter wherein the mechanical shutter comprises a shutter electrode and first and second control electrodes provided in a pair with respect to the shutter electrode, and a display device displays images by electrically controlling a position of the shutter. Each pixel has a pixel circuit that electrically controls a position of the mechanical shutter. The pixel circuit is provided with a first drive transistor that supplies a drive voltage to the first control electrode and a second drive transistor that supplies a drive voltage to the second control electrode The display is provided with a discharge period and a display period after the discharge period. During the discharge period Vs=VH, |Vs−Vp1|≦Vth, and |Vs−Vp2|≦2Vth, where Vs is a voltage supplied to the shutter electrode, Vp1 is a voltage supplied to the first control electrode, Vp2 is a voltage supplied to the second control electrode, and Vth is a threshold voltage of the first drive transistor and the second drive transistor.

(11) A plurality of pixels each having a mechanical shutter wherein the mechanical shutter is provided with a shutter electrode and first and second control electrodes provided in a pair with respect to the shutter electrode, and a display device that displays images by electrically controlling a position of the shutter electrode. Each pixel has a pixel circuit that electrically controls a position of the mechanical shutter. The pixel circuit is provided with a first drive transistor that supplies a drive voltage to the first control electrode and a second drive transistor that supplies a drive voltage to the second control electrode. The display is provided with a discharge period and a display period after the discharge period. During the discharge period Vs=VH−Vth, |Vs−Vp1|≦Vth, and |Vs−Vp2|≦Vth, where Vs is a voltage supplied to the shutter electrode, Vp1 is a voltage supplied to the first control electrode, Vp2 is a voltage supplied to the second control electrode, and Vth is a threshold voltage of the first drive transistor and the second drive transistor.

(12) In either of the examples (10) or (11) discussed above, the display device can include a plurality of video lines that input an image signal voltage to each pixel, a plurality of scan lines that input a scanning voltage to each pixel, a power supply line that supplies a common power supply voltage, a capacitor control voltage line that supplies a control voltage, a shutter voltage line that supplies a shutter control voltage, and an update voltage line that supplies an update voltage, where the pixel circuit is provided with: an input transistor where a source is connected to a corresponding video line from among the plurality of video lines, with a gate thereof connected to a corresponding scan line from among the plurality of scan lines; a storage capacitor that stores voltage output by the input transistor and has another end connected to the control voltage line while one end is connected to a drain of the input transistor; a first capacitor connected between the first drive transistor and the power supply line; and a second capacitor connected between the second drive transistor and the power supply line. With the first drive transistor, a gate is connected to a drain of the input transistor while a source is connected to the update voltage line, and a drain is connected to one end of the first capacitor. With the second drive transistor, a gate is connected to the drain of the first drive transistor while a source is connected to the update voltage line, and a drain terminal is connected to one end of the second capacitor. The first control electrode is connected to the drain of the first drive transistor, the second control electrode is connected to the drain of the second drive transistor, and the shutter electrode is connected to the shutter voltage line.

(13) In any of the examples (1) through (12) discussed above, a subfield has a field of a negative polarity drive state during the display period that applies a low drive voltage of VL to the shutter electrode and a subfield of a positive polarity drive state during the display period that applies a high drive voltage of VH with a voltage higher than the low voltage drive voltage of VL to the shutter electrode. The discharge period is inserted when switching from the field of the negative polarity drive state to the field of the positive polarity drive state or when switching from the field of the positive polarity drive state to the field of the negative polarity drive state.

### Effects of the Invention

A brief explanation of effects obtained by representative inventions among those disclosed in the present application is as described below.

According to the present invention, it is possible to supply a substantially equal voltage to a shutter electrode and a pair of control electrodes during a discharge period to prevent degradation of a mechanical shutter in an image display device with a movable shutter system.

### BRIEF DESCRIPTION OF DRAWINGS

FIG. 1 is a block diagram illustrating a schematic configuration of an image display device (hereafter referred to as an image display device with a movable shutter system) that performs image display by electrically controlling a position of a mechanical shutter according to a first embodiment of the present invention.

FIG. 2 is a block diagram illustrating a schematic configuration of the display panel illustrated in FIG. 1.

FIG. 3 is a circuit diagram illustrating a circuit configuration of pixels in the image display device with the movable shutter system according to the first embodiment of the present invention.

FIG. 4 is a cross-sectional view illustrating a cross-sectional structure of a pixel portion of the image display device with the movable shutter system according to the first embodiment of the present invention.

FIG. 5 is a diagram illustrating a timing chart for signals over various types of wiring in a pixel circuit illustrated in FIG. 3.

FIG. 6 is a diagram illustrating voltage changes of a shutter electrode, an OPEN electrode, and a CLOSE electrode during a discharge period A, a shutter movement period, an emission period, and a discharge period B in the image display device with the movable shutter system according to the first embodiment of the present invention.

FIG. 7 is a circuit diagram illustrating a circuit configuration of pixels in an image display device with a movable shutter system according to a second embodiment of the present invention.

FIG. 8 is a diagram illustrating a timing chart for signals over various types of wiring in a pixel circuit illustrated in FIG. 7.

FIG. 9 is a diagram illustrating voltage changes of each portion of each pixel circuit during a discharge period, an update and shutter movement period, and an emission period of LED lighting in a state of positive polarity in the image display device with the movable shutter system according to the second embodiment of the present invention.

FIG. 10 is a diagram illustrating voltage changes of each portion of each pixel circuit during the discharge period, the update and shutter movement period, and the emission period of LED lighting in a state of negative polarity in the image display device with the movable shutter system according to the second embodiment of the present invention.

FIG. 11 is a diagram illustrating voltage changes of a shutter electrode, an OPEN electrode, and a CLOSE electrode during a discharge period, a shutter movement period, and an emission period in the image display device of the movable shutter system according to the second embodiment of the present invention.

FIG. 12 is a diagram illustrating voltage changes of a shutter electrode, an OPEN electrode, and a CLOSE electrode during a discharge period, a shutter movement period, and an emission period in an image display device with a movable shutter system according to a third embodiment of the present invention.

FIG. 13 is a diagram illustrating voltage changes of a shutter electrode, an OPEN electrode, and a CLOSE electrode during a discharge period, a shutter movement period, and an emission period in an image display device with a movable shutter system according to a fourth embodiment of the present invention.

FIG. 14 is a diagram illustrating voltage changes of a shutter electrode, an OPEN electrode, and a CLOSE electrode during a discharge period, a shutter movement period, and an emission period in an image display device with a movable shutter system according to a fifth embodiment of the present invention.

FIG. 15 is a diagram illustrating voltage changes of a shutter electrode, an OPEN electrode, and a CLOSE electrode during a discharge period, a shutter movement period, and an emission period in an image display device with a movable shutter system according to a sixth embodiment of the present invention.

FIG. 16 is a diagram illustrating voltage changes of the shutter electrode, the OPEN electrode, and the CLOSE electrode during the discharge period, the shutter movement period, and the emission period in the image display device with the movable shutter system according to the fourth embodiment of the present invention.

FIG. 17 is a diagram illustrating voltage changes of a shutter electrode 208, an OPEN electrode, and a CLOSE electrode during an update period, a shutter movement period, and an emission period in a conventional image display device with a movable shutter system.

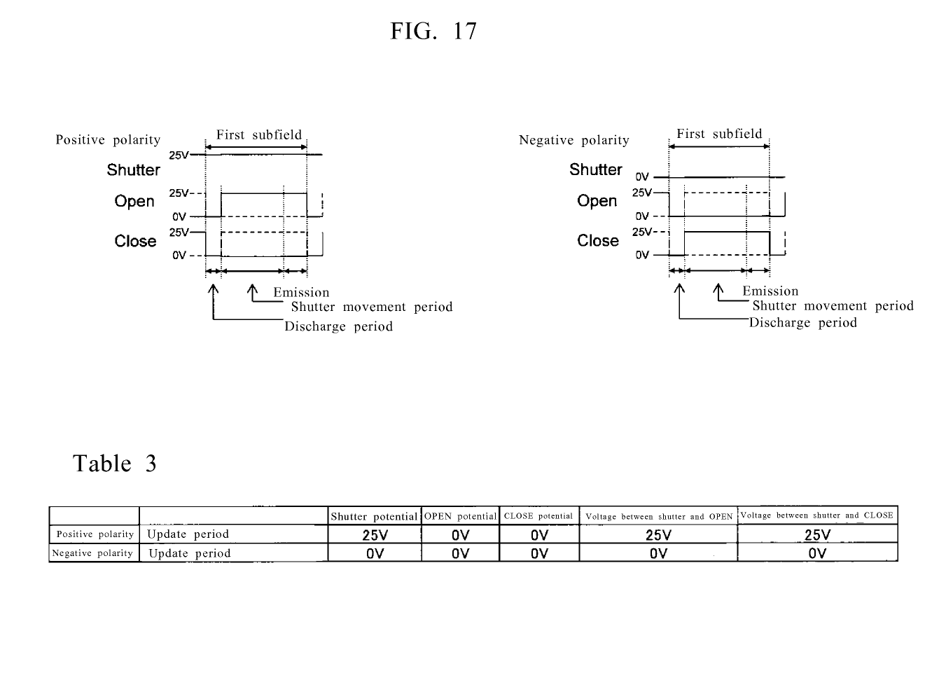

FIG. 18 is a schematic diagram of the shutter electrode provided for each pixel and one control electrode from among a pair of control electrodes in the image display device with the movable shutter system.

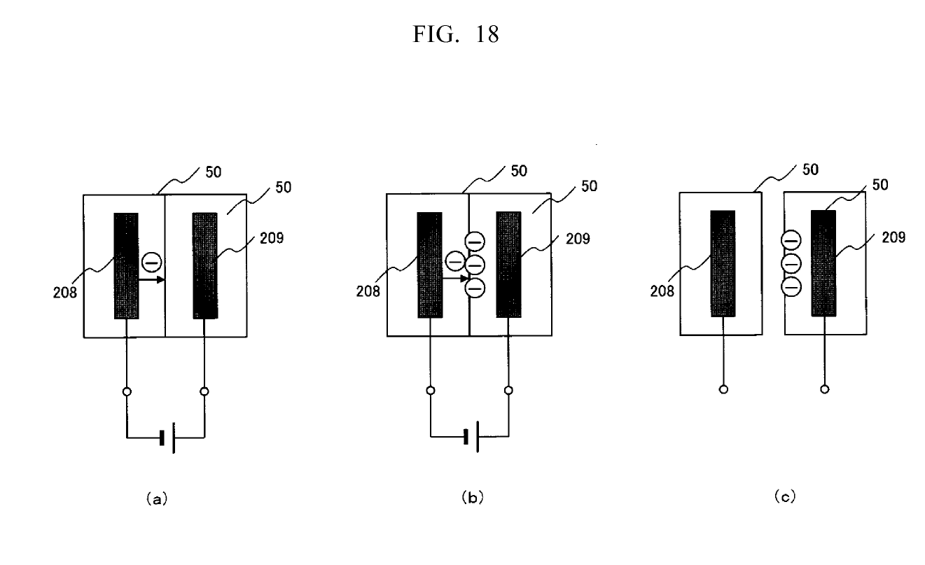

### EMBODIMENTS

Embodiments of the present invention are described in detail below with reference to the drawings.

Note that in every figure for describing the embodiments, the same reference numerals will be used for the same functions, and repeated descriptions will be omitted. Moreover, the embodiments below do not limit interpretation of the scope of patent claims of the present invention.

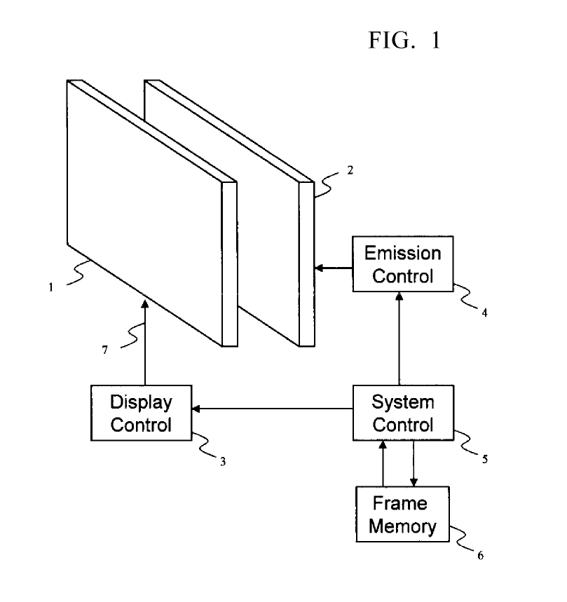

FIG. 1 is a block diagram illustrating a schematic configuration of an image display device (hereafter referred to as an image display device with a movable shutter system) that performs image display by electrically controlling a position of a mechanical shutter (hereafter referred to as a MEMS shutter) according to a first embodiment of the present invention.

In FIG. 1, the display device includes a display panel 1, a backlight 2, a display panel control device 3, a backlight control device 4, a system controller 5, a frame memory 6, and a control signal input 7 to the display panel 1.

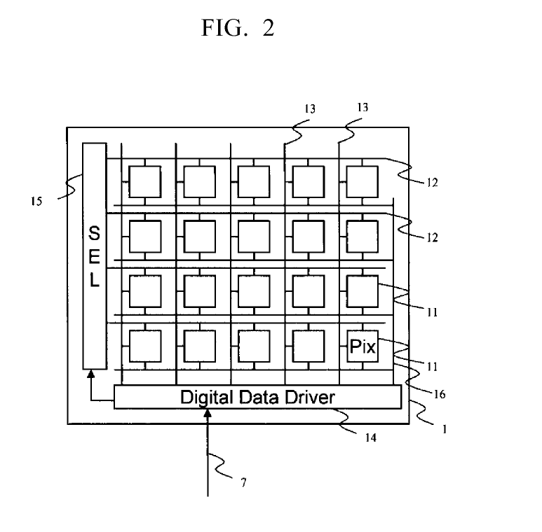

FIG. 2 is a block diagram illustrating a schematic configuration of the display panel 1 illustrated in FIG. 1.

As illustrated in FIG. 2, the display panel 1 illustrated in FIG. 1 has pixels 11 disposed in a matrix, and video lines 13, scanning lines 12, and various types of wiring 16 are input to each pixel. Moreover, the scanning line 12 is connected to a scanning line drive circuit 15, and the video line 13 and the various types of wiring 16 are input to a video line drive circuit 14.

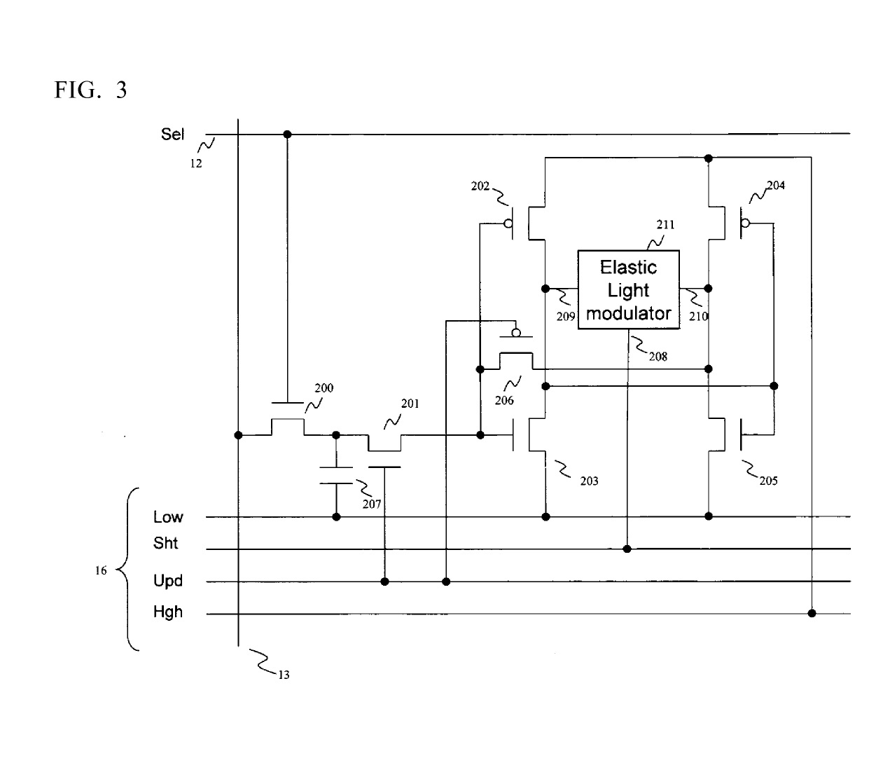

FIG. 3 is a circuit diagram illustrating a circuit configuration of the pixels in the image display device of the movable shutter system according to the first embodiment of the present invention.

As illustrated in FIG. 3, the various types of wiring 16 are configured by an update line (Upd), a shutter voltage line (Sht), a positive voltage line (Hgh), and a negative voltage line (Low).

In a pixel circuit according to the present embodiment, the video line 13 and a signal storage capacitor (hereafter referred to as a holding capacitor) 207 are connected by a scanning switch 200, and a gate of the scanning switch 200 is connected to the scanning line 12.

A first CMOS inverter circuit configured by a pMOS transistor 202 and an nMOS transistor 203 and a second CMOS inverter circuit configured by a pMOS transistor 204 and an nMOS transistor 205 are provided between the positive voltage line (Hgh) and the negative voltage line (Low).

Another end of the holding capacitor 207 is connected to the negative voltage line (Low), and one end is connected to a source (or a drain) of an nMOS transistor 201.

The drain (or the source) of the nMOS transistor 201 is connected to an input terminal (a gate of the pMOS transistor 202 and the nMOS transistor 203) of the first CMOS inverter circuit.

An output terminal (a drain of the pMOS transistor 202 and the nMOS transistor 203) of the first CMOS inverter circuit is connected to an input terminal (a gate of the pMOS transistor 204 and the nMOS transistor 205) of the second CMOS inverter circuit.

An output terminal (a drain of the pMOS transistor 204 and the nMOS transistor 205) of the second CMOS inverter circuit is connected to an input terminal (a gate of the pMOS transistor 202 and the nMOS transistor 203) of the second CMOS inverter circuit via a pMOS transistor 206.

Note that a gate of the nMOS transistor 201 and a gate of the pMOS transistor 206 are connected to the update line (Upd).

Each pixel 11 has a MEMS shutter 211, and a shutter electrode 208 is connected to the shutter voltage line (Sht).

Moreover, one control electrode 209 is connected to the output terminal of the first CMOS inverter circuit, and another control electrode 210 is connected to the output terminal of the second CMOS inverter circuit.

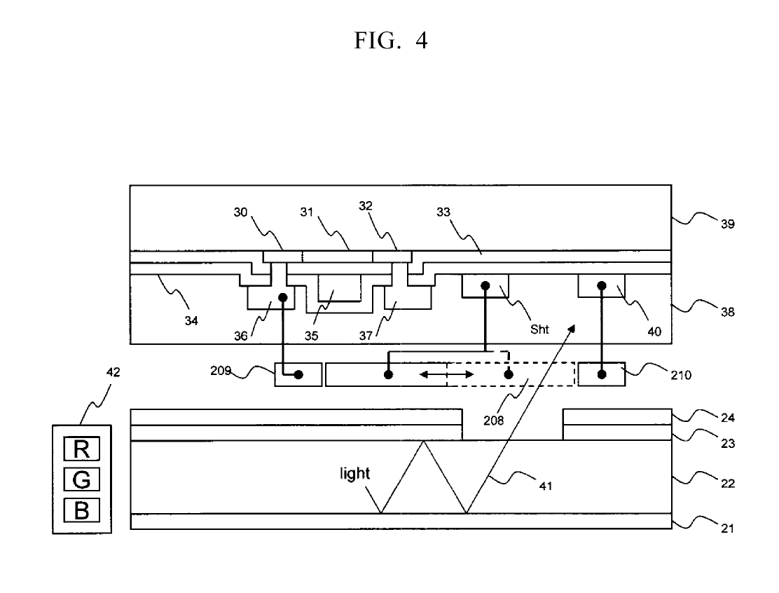

FIG. 4 is a cross-sectional view illustrating a cross-sectional structure of a pixel portion of the image display device with the movable shutter system according to embodiments of the present invention.

As illustrated in FIG. 4, a polycrystalline silicon thin film transistor configured from a polycrystalline silicon thin film 31, polycrystalline silicon thin films doped with a high-concentration n-type impurity (30, 32), a gate insulating film 33, a gate electrode 35 configured from a refractory metal, a source 37, and a drain electrode 36 (a drain electrode of an n-type MOS transistor 203 illustrated in FIG. 3) is provided on a glass substrate 39.

Furthermore, the shutter voltage line (Sht) and a drain electrode 40 (a drain electrode of an n-type MOS transistor 205 illustrated in FIG. 3) are formed in an Al wiring layer, along with the source 37 and the drain electrode 36, with an insulating protective film 34 interposed therebetween, and these are covered by a protective film 38 configured by a multilayer film of silicon nitride and organic material.

The shutter electrode 208 and the mechanical shutter 211 having the two control electrodes (209, 210) are provided on the protective film 38, and the shutter electrode 208, the drain electrode 36, and the drain electrode 40 are connected via a contact hole to the shutter voltage line (Sht), the control electrode 209, and the control electrode 210, respectively. Moreover, an insulating film is formed on a surface of the shutter electrode 208 and the control electrodes (209, 210) to prevent shorting due to mutual contact.

Here, because a position of the shutter electrode 208 is controlled by an electric field due to a relative relationship between a voltage input to the shutter electrode 208 and a voltage input to the control electrodes 209 and 210, a movable range is disclosed using a dashed line in FIG. 4.

Furthermore, although not illustrated in FIG. 3, other transistors provided in the pixels 11 are likewise configured from the polycrystalline silicon thin film transistor. These polycrystalline silicon thin film transistors can be formed using a known excimer laser annealing process or the like.

A light guide plate 22 having a light source 42 configured from independent light sources of three colors or R (red), G, (green), and B (blue) is provided on an opposite side of the glass substrate 39 relative to the shutter electrode 208. Note that the light source 42 and the light guide plate 22 configure the backlight.

Reflective films (21, 23) and a black film 24 are provided on both sides of the light guide plate 22 and the reflective film 23, respectively. The reflective films (21, 23) are metal films of Ag, Al, or the like, and the black film 24 can be formed by suitably dispersing pigment particles such as carbon black and titanium black on a polyimide resin or the like.

Here, as illustrated in FIG. 4, an opening is provided at a position corresponding to the shutter electrode 208 on the reflective film 23 and the black film 24, and a portion of a light 41 emitted from the light source 42 and propagated to the light guide plate 22 is configured to be emitted from this opening. Therefore, the position of the shutter electrode 208 can be controlled electrically to display image. Moreover, the black film 24 is provided to prevent reflection of external light.

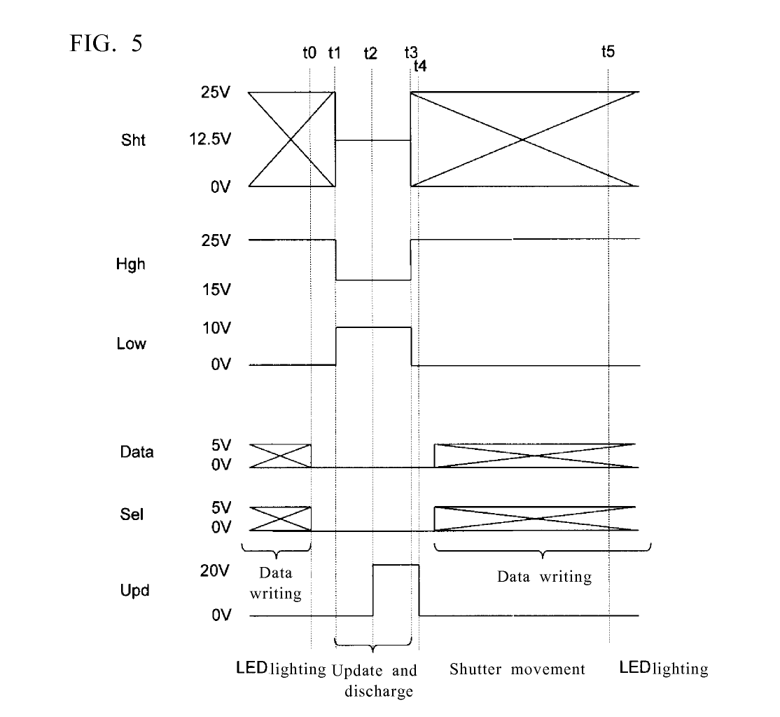

FIG. 5 is a diagram illustrating a timing chart for signals over the various types of wiring 16 in the pixel circuit illustrated in FIG. 3.

Note that in the description below, a high voltage VH (hereafter referred to as H level) will be 25 V, a low voltage VL (hereafter referred to as L level) will be 0 V, an intermediate voltage on a positive side will be 15 V, and an intermediate voltage on a negative side will be 10 V.

The shutter voltage line (Sht) is 25 V in a state of positive polarity nd 0 V in a state of negative polarity, but an x illustrates that both voltages exist in FIG. 5.

An operation of the pixel circuit illustrated in FIG. 3 will be described below using FIG. 5.

An image signal voltage applied to the video line 13 before an initial time (t0) is stored in the holding capacitor 207 via the scanning switch 200 by sequentially scanning the scanning line 12.

Next, after write scanning of the image signal voltage to the holding capacitor 207 of all of the pixels is completed, writing of image signals to the pair of control electrodes (209, 210) is performed in each pixel based on the written image signal voltage.

That is, at a time (t1), a voltage over the shutter voltage line (Sht) is made to be the intermediate voltage of 12.5 V, which is between 25 V and 0 V, for all of the pixels.

At the same time, a voltage over the positive voltage line (Hgh) is changed from the voltage of 25 V to the intermediate voltage on the positive side of 15 V, and a voltage over the negative voltage line (Low) is changed from the voltage of 0 V to the intermediate voltage on the negative side of 10 V.

Next, at a time (t2), a voltage of the update line (Upd) is changed from 0 V to 20 V.

By this, the pMOS transistor 206 turns off, and a feedback loop from the output terminal of the second CMOS inverter circuit to the input terminal of the first CMOS inverter circuit is blocked. Moreover, the nMOS transistor 201 turns on.

At this time, the voltage of the control electrode 209 of the pixels written with the high voltage (here, 5 V) as the image signal voltage in the holding capacitor 207 is rewritten as the voltage of 10 over the negative voltage line (Low) by the nMOS transistor 203 turning on.

Furthermore, the voltage of the control electrode 209 of the pixels written with the low voltage (here, 0 V) as the image signal voltage in the holding capacitor 207 is rewritten as the voltage of 15 V over the positive voltage line (Hgh) by the pMOS transistor 202 turning on.

Next, at a time (t3), a voltage over the shutter voltage line (Sht) is made to be 25 V, and at the same time, a voltage over the positive voltage line (Hgh) is made to be 25 V, and a voltage over the negative voltage line (Low) is made to be 0 V.

By this, the voltage of the control electrode 209 of the pixels written with the high voltage (5 V) as the image signal voltage in the holding capacitor 207 is rewritten as the voltage of 0 V over the negative voltage line (Low).

Furthermore, the voltage of the control electrode 209 of the pixels written with the low voltage (0 V) as the image signal voltage of the holding capacitor 207 is rewritten as the voltage of 25 V over the positive voltage line (Hgh).

Next, at a time (t4), a voltage applied to the update line (Upd) is changed from 20 V to 0 V.

This causes the nMOS transistor 201 to turn off and the pMOS transistor 206 to turn on, and the feedback loop from the output terminal of the second CMOS inverter circuit to the input terminal of the first CMOS inverter circuit is formed.

As a result, the voltage of the control electrode 209 of the pixels written with the high voltage (5 V) as the image signal voltage in the holding capacitor 207 becomes the voltage of 0 V over the negative voltage line (Low), and the voltage of the control electrode 210 becomes the voltage of 25 V over the positive voltage line (Hgh).

Furthermore, the voltage of the control electrode 209 of the pixels written with the low voltage (0 V) as the image signal voltage in the holding capacitor 207 becomes the voltage of 25 V over the positive voltage line (Hgh), and the voltage of the control electrode 210 becomes the voltage of 0 V over the negative voltage line (Low).

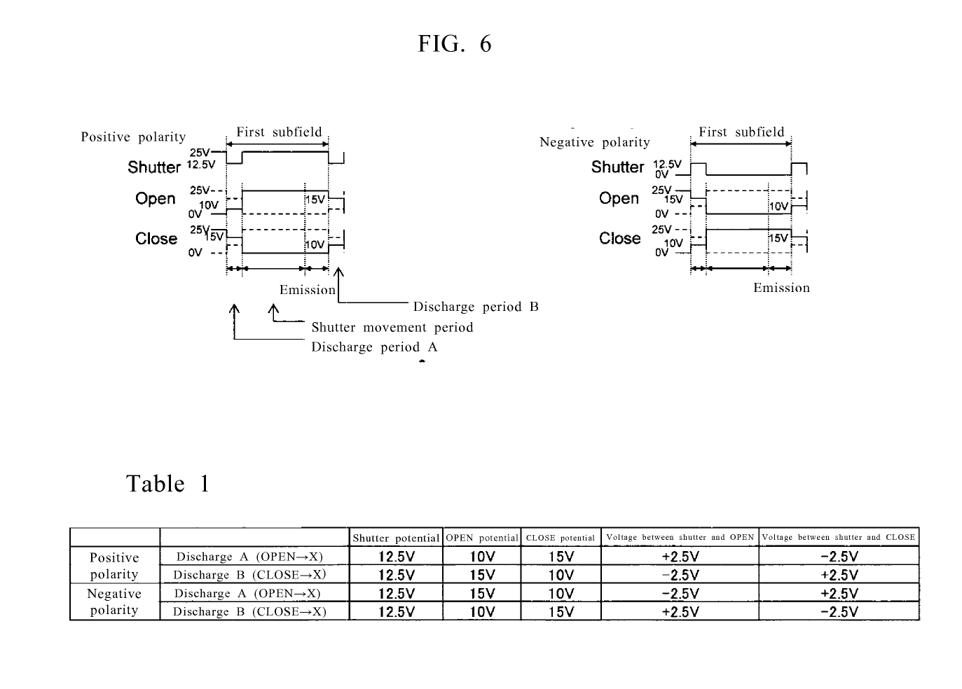

The shutter electrode 208 and the pair of control electrodes (209, 210) in the drive method illustrated in FIG. 5 are operated with a voltage such as that in FIG. 6.

Note that an update period and a discharge period in FIG. 6 are periods from the time t2 to the time t3 in FIG. 5, a shutter movement period in FIG. 6 is a period from the time t3 to t5 in FIG. 5, and an emission period of LED lighting in FIG. 6 is a period from the time t5 and after in FIG. 5.

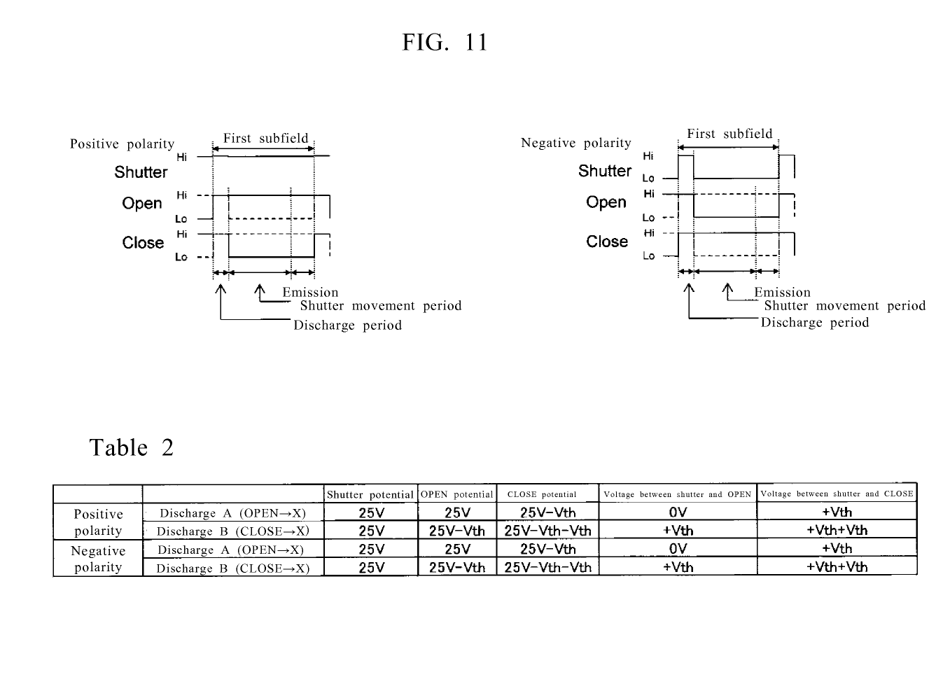

Note that in FIG. 6, as well as in FIGS. 11 to 16 that will be described below, the shutter electrode is illustrated as “Shutter,” the OPEN electrode as “OPEN,” and the CLOSE electrode as “CLOSE.”

Below, the control electrode 209 will be described as the OPEN electrode and the control electrode 210 as the CLOSE electrode.

The image display device of the movable shutter system according to the present embodiment displays a color image in a field sequential method and controls gradation of a color image displayed in a subfield method. In the present embodiment, each subfield includes the discharge period (a discharge period A or a discharge period B), the shutter movement period, and the emission period of LED lighting.

Here, the discharge period A is the discharge period from when the MEMS shutter 211 opens to when the MEMS shutter 211 opens or closes, and the discharge period B is the discharge period from when the MEMS shutter 211 closes to when the MEMS shutter opens or closes.

FIG. 6 is a diagram illustrating voltage changes of the shutter electrode 208, the OPEN electrode, and the CLOSE electrode relating to the discharge period A, the shutter movement period, the emission period, and the discharge period B in the image display device of the movable method according to the first embodiment of the present invention.

In the discharge period A in the state of positive polarity, the voltage of the shutter electrode 208 is 12.5 V, the voltage of the OPEN electrode is 10 V, the voltage of the CLOSE electrode is 15 V, and an average value of the voltage of the OPEN electrode and the voltage of the CLOSE electrode is the same value as the voltage of the shutter electrode 208. Therefore, a voltage between the shutter electrode 208 and the OPEN electrode becomes +2.5 V, and a voltage between the shutter electrode 208 and the CLOSE electrode becomes −2.5 V.

Similarly, the voltage of the shutter electrode 208, the voltage of the OPEN electrode, the voltage of the CLOSE electrode, the voltage between the shutter electrode 208 and the OPEN electrode, and the voltage between the shutter electrode 208 and the CLOSE electrode, which relate to the discharge period B of the state of positive polarity, the discharge period A of the state of negative polarity, and the discharge period B of the state of negative polarity, become as shown in Table 1.

Note that in table 1, the voltage of the shutter electrode 208 is described as “Shutter potential,” the voltage of the OPEN electrode as “OPEN potential,” the voltage of the CLOSE electrode as “CLOSE potential,” the voltage between the shutter electrode 208 and the OPEN electrode as “Voltage between shutter and OPEN,” and the voltage between the shutter electrode 208 and the CLOSE electrode as “Voltage between shutter and CLOSE.”

In the voltage relationship as shown in Table 1, first, the voltage between each electrode during the discharge period, i.e., the voltage between the shutter electrode 208 and the OPEN electrode and the voltage between the shutter electrode 208 and the CLOSE electrode, is either +2.5 V or −2.5 V, which is sufficiently small (the electric field is mitigated) compared to a voltage between electrodes during the shutter movement period or the emission period (+25 V or −25 V), and an effect of a charge injected into the insulating film returning to an electrode side (a charge injection amount) is therefore obtained.

Furthermore, because an absolute value of the voltage between the shutter electrode 208 and the OPEN electrode and the voltage between the shutter electrode 208 and the CLOSE electrode are the same, a degree of the effect of the charge injected into the insulating film returning to the electrode side is the same for an OPEN side and a CLOSE side.

Furthermore, because electric field directions of the discharge period A and the discharge period B are inverted for each voltage between electrodes within one polarity, these become electrically symmetrical, and the charge injection amount stabilizes at around 0.

Furthermore, because each voltage between electrodes of the discharge period A of the state of positive polarity and each voltage between electrodes of the discharge period A of the state of negative polarity are electrically inverted, these become electrically symmetrical when an open state of the MEMS shutter 211 continues (same when a close state of the MEMS shutter 211 continues), and the charge injection amount therefore stabilizes at around 0.

As described above, by performing an operation such as that illustrated in FIG. 6, the charge injection amount can be decreased by electrical field mitigation for each subfield to stabilize the charge injection amount at around 0, and reliability of the image display device of the movable shutter system according to the present embodiment can therefore be improved.

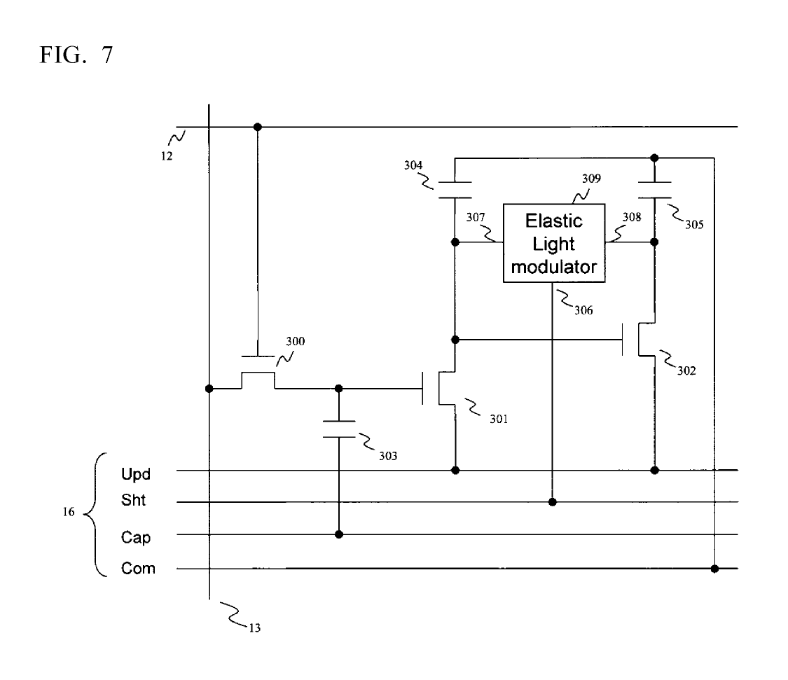

FIG. 7 is a circuit diagram illustrating a circuit configuration of pixels in an image display device with a movable shutter system according to a second embodiment of the present invention.

Note that in the present embodiment, a schematic configuration of the image display device with the movable shutter system, the schematic configuration of a display panel, and a cross-sectional structure of a pixel portion are the same as in FIGS. 1, 2, and 4.

As illustrated in FIG. 7, various types of wiring 16 are configured by an update line (Upd), a shutter voltage line (Sht), a capacitor control voltage line (Cap), and a common power supply line (Com).

In a pixel circuit according to the present embodiment, a video line 13 and a signal storage capacitor (hereafter referred to as a holding capacitor) 303 are connected by a scanning switch 300, and a gate of the scanning switch 300 is connected to a scanning line 12.

Another end of the holding capacitor 303 is connected to the capacitor control voltage line (Cap), and one end is connected to a gate of an nMOS transistor 301.

A source of the nMOS transistor 301 is connected to an update line (Upd), and a drain of the nMOS transistor 301 is connected to the common power supply line (Com) via a first capacitor 304.

The drain of the nMOS transistor 301 is connected to a gate of the nMOS transistor 302, a source of the nMOS transistor 302 is connected to the update line (Upd), and a drain of the nMOS transistor 302 is connected to the common power supply line (Com) via a second capacitor 305.

Here, a voltage normally at an L level (here, 0 V) is supplied to the common power supply line (Com).

Each pixel 11 has a MEMS shutter 309, and a shutter electrode 306 is connected to the shutter voltage line (Sht).

Furthermore, one control electrode 307 is connected to the drain of the nMOS transistor 301, and another control electrode 308 is connected to the drain of the nMOS transistor 302.

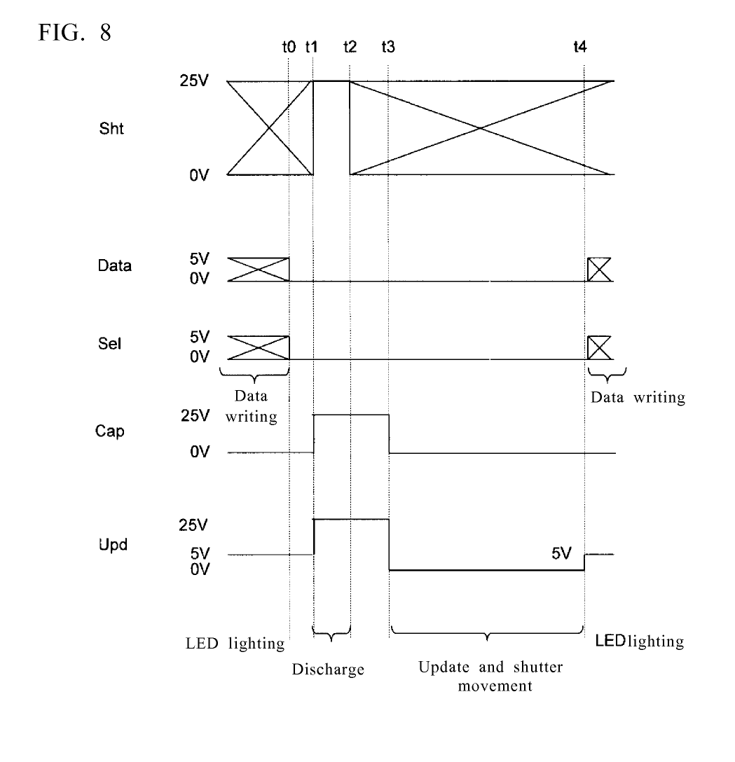

FIG. 8 is a diagram illustrating a timing chart for signals over the various types of wiring 16 in the pixel circuit illustrated in FIG. 7. Note that the shutter voltage line (Sht) is 25 V in a state of positive polarity and 0 V in a state of negative polarity. In FIG. 8, an x illustrates that both voltages exist.

An operation of the pixel circuit illustrated in FIG. 7 will be described below using FIG. 8. Note that in the description below, a voltage of a VH of an H level will be described as 25 V and a voltage of a VL of an L level as 0 V.

The image display device of the movable shutter system according to the present embodiment displays a color image with a field sequential method and controls gradation of a color image displayed with a subfield method. In the present embodiment, each subfield includes a discharge period, an update and shutter movement period, and an emission period of LED lighting.

An image signal voltage applied to the video line 13 before a time (t0) is stored in the holding capacitor 303 via the scanning switch 300 by sequentially scanning the scanning line 12.

Next, at a time (t1) after write scanning the image signal voltage to the holding capacitor 303 of all the pixels is completed, a voltage over the shutter voltage line (Sht) is made to be 25 V. At the same time, a voltage over the capacitor control voltage line (Cap) is changed from 0 V to 25 V, and a voltage over the update line (Upd) is changed from an intermediate voltage on a negative side of 5 V to 25 V.

Next, at a time t2, the voltage over the shutter voltage line is changed from 25 V to 0 V.

Next, at a time t3, the voltage over the capacitor control voltage line (Cap) and the update line (Upd) is changed from 25 V to 0 V.

Operations will be described below for a case where 5 V is applied to the holding capacitor 303 during a data writing period when the voltage of the shutter voltage line (Sht) is in a state of positive polarity of 25 V (hereafter referred to as case 1), a case where 0 V is applied to the holding capacitor 303 during a data writing period when the voltage of the shutter voltage line (Sht) is in a state of positive polarity of 25 V (hereafter referred to as case 2), a case where 5 V is applied to the holding capacitor 303 during a data writing period when the voltage of the shutter voltage line (Sht) is in a state of negative polarity of 0 V (hereafter referred to as case 3), and a case where 0 V is applied to the holding capacitor 303 during a data writing period when the voltage of the shutter voltage line (Sht) is in a state of positive polarity of 0 V (hereafter referred to as case 4).

Note that the control electrode 307 will be described as an OPEN electrode and the control electrode 308 as a CLOSE electrode in the description below.

(1) Case 1

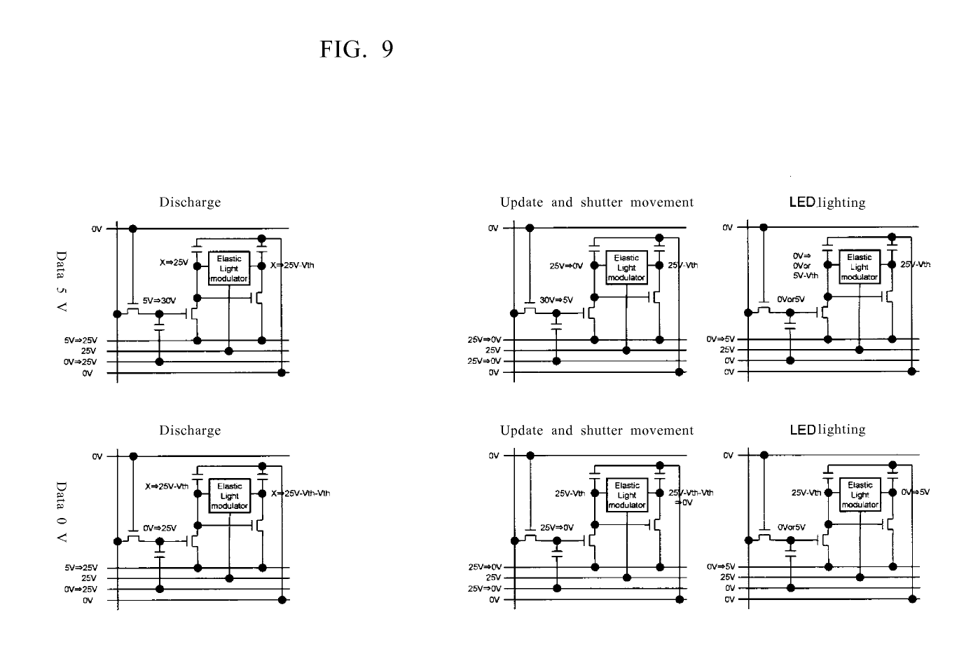

FIG. 9 is a diagram illustrating voltage changes of each portion of each pixel circuit during the discharge period, the update and shutter movement period, and the emission period of LED lighting in the state of positive polarity in the image display device with the movable shutter system according to the second embodiment of the present invention.

Note that the discharge period in FIG. 9 is a period from the time t1 to the time t2 in FIG. 8, the update and shutter movement period in FIG. 9 is a period from the time t3 to a time t4 in FIG. 8, and the emission period of LED lighting in FIG. 9 is a period from a time t4 and after in FIG. 8.

In the state of positive polarity, when 5 V (data 5 V in FIG. 9) is input to the holding capacitor 303 during the data writing period, because the voltage over the capacitor control voltage line (Cap) changes from 0 V to 25 V at the time t1, a gate voltage of the nMOS transistor 301 changes from 5 V to 30 V via the holding capacitor 303.

Here, because the voltage over the update line (Upd) is 25 V and a voltage between source gates of the nMOS transistor 301 is 5 V, the nMOS transistor 301 turns on, and 25 V, the voltage over the update line (Upd), is supplied to the OPEN electrode 307.

Because the voltage over the update line (Upd) is 25 V and the gate voltage is 25 V for the nMOS transistor 302, a voltage between source gates of the nMOS transistor 302 becomes 0 V, and the nMOS transistor 302 turns off.

However, the voltage of the CLOSE electrode 308 toggles the nMOS transistor 302.

The voltage of the CLOSE electrode 308 before the time t1 is decided by the state of polarity (positive polarity or negative polarity) and an open or closed state of the MEMS shutter 309, and there are two states of 5 V and (25 V−Vth). Note that Vth is a threshold voltage of the nMOS transistor 301 and the nMOS transistor 302.

If the voltage of the CLOSE electrode 308 is lower (5 V) than the gate voltage of the nMOS transistor 302, an electrode (drain) on a CLOSE electrode 308 side becomes the source, and the nMOS transistor 302 turns on.

When the nMOS transistor 302 turns on, the voltage of the CLOSE electrode 308 rises toward the voltage of the update line (Upd) and, upon reaching the voltage of (25 V−Vth) that takes into consideration the threshold voltage (Vth) of the nMOS transistor 302, the nMOS transistor 302 turns off.

If the voltage of the CLOSE electrode 308 is (25 V−Vth), there is no change because the voltage has already reached the threshold voltage of the nMOS transistor 302.

At this time, because 25 V are applied to the shutter voltage line (Sht), the voltage of the shutter electrode 306, the voltage of the OPEN electrode 307, and the voltage of the CLOSE electrode 308 all become around 25 V (25 V−Vth or 25 V), and this can be made the discharge period.

Next, at the time t3, the voltage over the update line (Upd) and the voltage over the capacitor control voltage line (Cap) become 0 V.

Because the gate voltage of the nMOS transistor 301 is connected to the capacitor control voltage line (Cap) via the holding capacitor 303, the gate voltage of the nMOS transistor 301 changes from 30 V to 5 V.

Therefore, because the voltage between the source gates of the nMOS transistor 301 maintains 5 V, the nMOS transistor 301 maintains on, and the voltage of the OPEN electrode 307 changes from 25 V to 0 V, the voltage over the update line (Upd).

Concerning the nMOS transistor 302, because a voltage of an electrode (source) on an update line (Upd) side changes to 0 V and the gate voltage also changes to 0 V, the nMOS transistor 302 generally maintains an off state.

However, because the gate voltage is supplied via the nMOS transistor 301, the gate voltage is delayed relative to voltage change of the update line (Upd).

If the delay is significant and the voltage between the source gates of the nMOS transistor 302 exceeds the threshold voltage of Vth, the nMOS transistor 302 turns on, and the voltage of the CLOSE electrode 308 becomes unable to be maintained at around 25 V.

Therefore, while not illustrated in FIG. 7, as a delay countermeasure, a high resistance is preferably inserted between the nMOS transistor 302 and the update line (Upd).

As described above, because the voltage of the shutter electrode 306 is 25 V, the voltage of the OPEN electrode 307 is 0 V, and the voltage of the CLOSE electrode 308 is (25 V−Vth), the shutter electrode 306 moves to the OPEN electrode 307.

(2) Case 2

In the state of positive polarity, during the data writing period, if 0 V are input to the holding capacitor (data 0 V in FIG. 9), the gate voltage of the nMOS transistor 301 changes from 0 V to 25 V via the holding capacitor 303 when the voltage over the capacitor control voltage line (Cap) changes from 0 V to 25 V at the time t1.

Because the source is 25 V and the gate electrode is 25 V for the nMOS transistor 301, with the source as a base, the voltage between the source gates of the nMOS transistor 301 becomes 0 V and the nMOS transistor 301 turns off.

Meanwhile, the voltage of the OPEN electrode 307 is 0 V or (5 V−Vth), or (25 V−Vth), due to a previous display state.

When the voltage of the OPEN electrode 307 is 0 V or (5 V−Vth) due to the previous display state, because an electrode (drain) on an OPEN electrode 307 side becomes the source and the nMOS transistor 301 turns on, the voltage of the OPEN electrode 307 changes from the voltage of 25 V over the update line (Upd) to the value (25 V−Vth) that depends on the threshold voltage of the nMOS transistor 301.

When the voltage of the OPEN electrode 307 is (25 V−Vth) due to the previous display state, the nMOS transistor 301 does not turn on and the voltage of the OPEN electrode 307 is maintained at (25 V−Vth).

Concerning the nMOS transistor 302, the voltage of the CLOSED electrode 308 is 5 V or (25 V−Vth) due to the previous display state.

When the voltage of the CLOSE electrode 308 is 5 V due to the previous display state, the nMOS transistor 302 turns on with an electrode (drain) on a CLOSE electrode 308 side as the source, and the voltage of the CLOSE electrode 308 rises to (25 V−Vth−Vth), a value that depends on the threshold voltage of the nMOS transistor 302, as opposed to the voltage (25 V−Vth) of the gate of the nMOS transistor 302.

When the voltage of the CLOSE electrode 308 is (25 V−Vth) due to the previous display state, the nMOS transistor 302 remains off and the voltage of the CLOSE electrode 308 remains (25 V−Vth).

At this time, because 25 V are supplied to the shutter voltage line (Sht), the voltage of the shutter electrode 306, the voltage of the OPEN electrode 307, and the voltage of the CLOSE electrode 308 all become around 25 V (i.e, 25 V−Vth−Vth, 25 V−Vth, and 25 V−Vth, respectively), and this can be made the discharge period.

Next, at the time t3, the voltage of the update line (Upd) and the voltage over the capacity control voltage line (Cap) become 0 V.

Because the gate voltage of the nMOS transistor 301 is connected to the capacity control voltage line (Cap) via the holding capacitor 303, the gate voltage of the nMOS transistor 301 changes from 25 V to 0 V.

Therefore, because the voltage between the source gates of the nMOS transistor 301 continues to be 0 V, the nMOS transistor 301 turns off and the OPEN electrode 307 maintains the voltage of (25 V−Vth).

Because the gate voltage becomes (25 V−Vth) and the source becomes 0 V for the nMOS transistor 302, the nMOS transistor 302 turns on and the voltage of the CLOSE electrode 308 becomes 0 V.

As described above, because the voltage of the shutter electrode 306 becomes 25 V, the voltage of the OPEN electrode 307 becomes (25 V−Vth), and the voltage of the CLOSE electrode 308 becomes 0 V, the shutter electrode 306 moves to the CLOSE electrode 308 side.

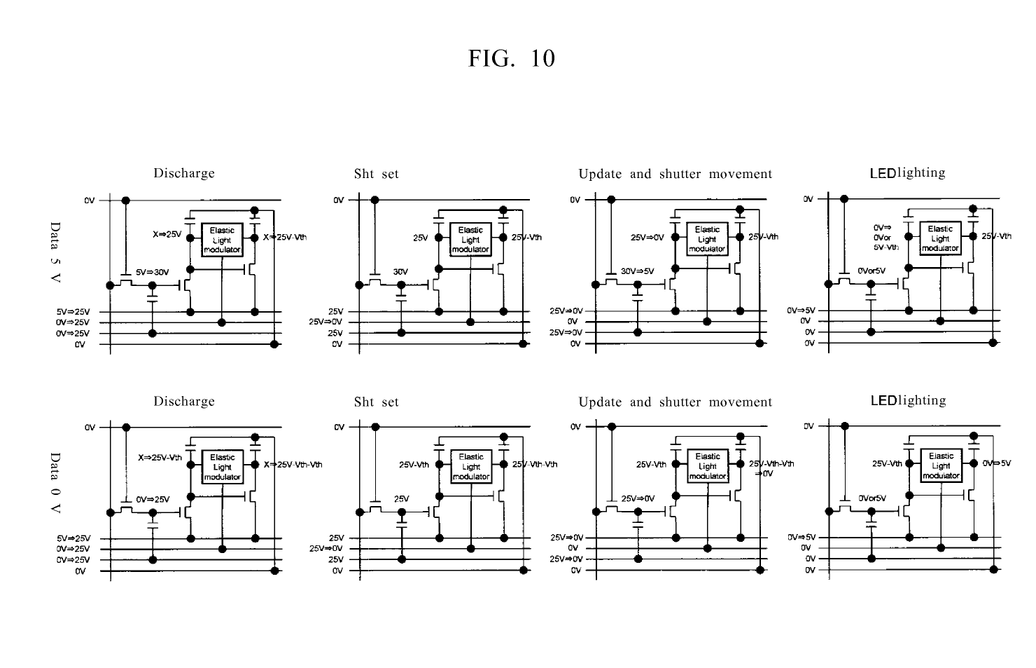

FIG. 10 is a diagram illustrating voltage changes of each portion of each pixel circuit during the discharge period, the update and shutter movement period, and the emission period of LED lighting in the state of negative polarity in the image display device with the movable shutter system according to the second embodiment of the present invention.

Note that the discharge period in FIG. 10 is the period from the time t1 to the time t2 in FIG. 8, a Sht set period in FIG. 10 is a period from the time t2 to the time t3 in FIG. 8, the update and shutter movement period in FIG. 10 is the period from the time t3 to the time t4 in FIG. 8, and the emission period of LED lighting in FIG. 10 is the period from the time t4 and after in FIG. 8.

(3) Case 3

In the state of positive polarity, the voltage over the shutter voltage line (Sht) is 25 V during the discharge period, the update and shutter movement period, and the emission period of LED lighting, but in the state of negative polarity, the voltage over the shutter voltage line (Sht) is 25 V during the discharge period while the voltage over the shutter voltage line (Sht) is 0 V during the update and shutter movement period and the emission period of LED lighting.

In the state of negative polarity, if 5 V is input to the holding capacitor 303 during the data writing period (data 5 V in FIG. 10), because the voltage over the capacitor control voltage line (Cap) changes from the voltage of 0 V to the voltage of 25 V at the time t1, the gate voltage of the nMOS transistor 301 changes from 5 V to 30 V via the holding capacitor 303.

Here, because the voltage over the update line (Upd) is 25 V and the voltage between source gates of the nMOS transistor 301 is 5 V, the nMOS transistor 301 turns on, and 25 V, the voltage over the update line (Upd), is supplied to the OPEN electrode 307.

Because the voltage over the update line (Upd) is 25 V and the gate voltage is 25 V for the nMOS transistor 302, the voltage between source gates of the nMOS transistor 302 becomes 0 V, and the nMOS transistor 302 turns off.

However, the voltage of the CLOSE electrode 308 toggles the nMOS transistor 302.

The voltage of the CLOSE electrode 308 before the time t1 is decided by the state of polarity (positive polarity or negative polarity) and the open or closed state of the MEMS shutter 309, and there are two states of 5 V and (25 V−Vth).

If the voltage of the CLOSE electrode 308 is 5 V and lower than the gate voltage of the nMOS transistor 302, the electrode (drain) on the CLOSE electrode 308 side becomes the source, and the nMOS transistor 302 turns on.

When the nMOS transistor 302 turns on, the voltage of the CLOSE electrode 308 rises toward the voltage of the update line (Upd) and, upon reaching the voltage of (25 V−Vth) that depends on the threshold voltage (Vth) of the nMOS transistor 302, the nMOS transistor 302 turns off.

If the voltage of the CLOSE electrode 308 is (25 V−Vth), there is no change because the voltage has already reached the threshold voltage of the nMOS transistor 302.

At this time, because 25 V are applied to the shutter voltage line (Sht), the voltage of the shutter electrode 306, the voltage of the OPEN electrode 307, and the voltage of the CLOSE electrode 308 all become around 25 V (25 V−Vth or 25 V), and this can be made the discharge period.

Next, at the time t2, the voltage over the shutter voltage line (Sht) becomes 0 V.

Next, at the time t3, the voltage over the update line (Upd) and the voltage over the capacity control voltage line (Cap) become 0 V.

Because the gate voltage of the nMOS transistor 301 is connected to the capacity control voltage line (Cap) via the holding capacitor 303, the gate voltage of the nMOS transistor 301 changes from 30 V to 5 V.

Therefore, because the voltage between the source gates of the nMOS transistor 301 continues to be 5 V, the nMOS transistor 301 continues to be on, and the OPEN electrode 307 changes from 25 V to 0 V, the voltage over the update line (Upd).

Concerning the nMOS transistor 302, because the electrode (source) on the update line (Upd) side changes to 0 V and the gate voltage also changes to 0 V, the nMOS transistor 302 generally maintains an off state.

However, because the gate voltage is supplied voltage via the nMOS transistor 301, the gate voltage is delayed relative to voltage change of the update line (Upd).

If the delay is significant and the voltage between the source and gate of the nMOS transistor 302 exceeds the threshold voltage Vth, the nMOS transistor 302 turns on, and the voltage of the CLOSE electrode 308 becomes unable to be maintained at around 25 V.

Therefore, as described above, to avoid excessive delay, the high resistance is preferably inserted between the nMOS transistor 302 and the update line (Upd).

As described above, because the voltage of the shutter electrode 306 is 0 V, the voltage of the OPEN electrode 307 is 0 V, and the voltage of the CLOSE electrode 308 is (25 V−Vth), the shutter electrode 306 moves to the OPEN electrode 307.

(4) Case 4

In the state of negative polarity, during the data writing period, if 0 V are input to the holding capacitor (data 0 V in FIG. 10), the gate voltage of the nMOS transistor 301 changes from 0 V to 25 V via the holding capacitor 303 when the voltage over the capacity control voltage line (Cap) changes from 0 V to 25 V at the time t1.

Because the source is 25 V and the gate electrode is 25 V for the nMOS transistor 301, with the source as a base, the voltage between the source gates of the nMOS transistor 301 becomes 0 V and the nMOS transistor 301 turns off.

Meanwhile, the voltage of the OPEN electrode 307 is 0 V or (5 V−Vth), or (25 V−Vth), due to the previous display state.

When the voltage of the OPEN electrode 307 is 0 V or (5 V−Vth) due to the previous display state, because the electrode (drain) on the OPEN electrode 307 side becomes the source and the nMOS transistor 301 turns on, the voltage of the OPEN electrode 307 changes from the voltage of 25 V over the update line (Upd) to the value (25 V−Vth) that depends on the threshold voltage (Vth) of the nMOS transistor 301.

When the voltage of the OPEN electrode 307 is (25 V−Vth) due to the previous display state, the nMOS transistor 301 does not turn on and the voltage of the OPEN electrode 307 is maintained at (25 V−Vth).

Concerning the nMOS transistor 302, the voltage of the CLOSED electrode 308 is 5 V or (25 V−Vth) due to the previous display state.

When the voltage of the CLOSE electrode 308 is 5 V due to the previous display state, the nMOS transistor 302 turns on with the electrode (drain) on the CLOSE electrode 308 side as the source, and the voltage of the CLOSE electrode 308 rises to (25 V−Vth−Vth), the value that depends on the threshold voltage (Vth) of the nMOS transistor 302, relative to the voltage (25 V−Vth) of the gate of the nMOS transistor 302.

When the voltage of the CLOSE electrode 308 is (25 V−Vth) due to the previous display state, the nMOS transistor 302 remains off and the voltage of the CLOSE electrode 308 remains (25 V−Vth).

At this time, because 25 V are supplied to the shutter voltage line (Sht), the voltage of the shutter electrode 306, the voltage of the OPEN electrode 307, and the voltage of the CLOSE electrode 308 all become around 25 V (25 V−Vth−Vth, 25 V−Vth, or 25−Vth), and this can be made the discharge period.

Next, at the time t2, the voltage over the shutter voltage line (Sht) becomes 0 V.

Next, at the time t3, the voltage of the update line (Upd) and the voltage over the capacitor control voltage line (Cap) become 0 V.

Because the gate voltage of the nMOS transistor 301 is connected to the capacity control voltage line (Cap) via the holding capacitor 303, the gate voltage of the nMOS transistor 301 changes from 25 V to 0 V.

Therefore, because the voltage between the source gates of the nMOS transistor 301 maintains 0 V, the nMOS transistor 301 turns off and the OPEN electrode 307 maintains the voltage of (25 V−Vth).

Because the gate voltage becomes (25 V−Vth) and the source becomes 0 V for the nMOS transistor 302, the nMOS transistor 302 turns on and the voltage of the CLOSE electrode 308 becomes 0 V.

As described above, because the voltage of the shutter electrode 306 becomes 0 V, the voltage of the OPEN electrode 307 becomes (25 V−Vth), and the voltage of the CLOSE electrode 308 becomes 0 V, the shutter electrode 306 moves to the OPEN electrode 307 side.

Note that because the voltage of (25 V−Vth) and the voltage of (25 V−Vth−Vth) are floating voltages, when the shutter electrode 306 moves and a capacitance between the shutter electrode 306 and an electrode on a pulling side increases, the voltage of the electrode on the pulling side decreases and the shutter electrode 306 is no longer able to retract sufficiently.

Because of this, a first capacitor 304 and a second capacitor 305 are added to the OPEN electrode 307 and the CLOSE electrode 308, respectively. This first capacitor 304 and second capacitor 305 need to be sufficiently larger than the capacitance formed between the shutter electrode 306 and the electrode on the pulling side.

Because a pixel area is limited, it is assumed that there are situations where the pixel area is insufficient, and in such situations, imparting amplitude to the voltage over the common power supply line (Com) can be of aid.

According to the drive method illustrated in FIGS. 9 and 10, the shutter electrode 306 and the pair of control electrodes (307, 308) operate at a voltage such as illustrated in FIG. 11.

As illustrated in FIG. 11, shutter life improves due to the discharge period provided for each subfield. Note that shutter life is further improved when the voltage of the shutter voltage line (Sht) during the discharge period is made to be (25 V−Vth) or (25 V−Vth) because a bias of a voltage between the shutter electrode 306 and the CLOSE electrode 308 is thereby reduced.

Note that FIG. 11 is a diagram illustrating voltage changes of the shutter electrode, the OPEN electrode, and the CLOSE electrode relating to the discharge period, the shutter movement period, and the emission period in the image display device with the movable shutter system according to the second embodiment of the present invention.

In the image display device with the movable shutter system according to the second embodiment of the present invention, the voltage of the shutter electrode 306, the voltage of the OPEN electrode 307, the voltage of the CLOSE electrode 308, the voltage between the shutter electrode 208 and the OPEN electrode 307, and the voltage between the shutter electrode 208 and the CLOSE electrode 308, which relate to the discharge period of the state of positive polarity, the discharge period B of the state of positive polarity, the discharge period A of the state of negative polarity, and the discharge period B of the state of negative polarity, become as shown in table 2.

Note that in Table 2, the voltage of the shutter electrode 306 is described as “Shutter potential,” the voltage of the OPEN electrode 307 as “OPEN potential,” the voltage of the CLOSE electrode 308 as “CLOSE potential,” the voltage between the shutter electrode 208 and the OPEN electrode 307 as “Voltage between shutter and OPEN,” and the voltage between the shutter electrode 208 and the CLOSE electrode 308 as “Voltage between shutter and CLOSE.”

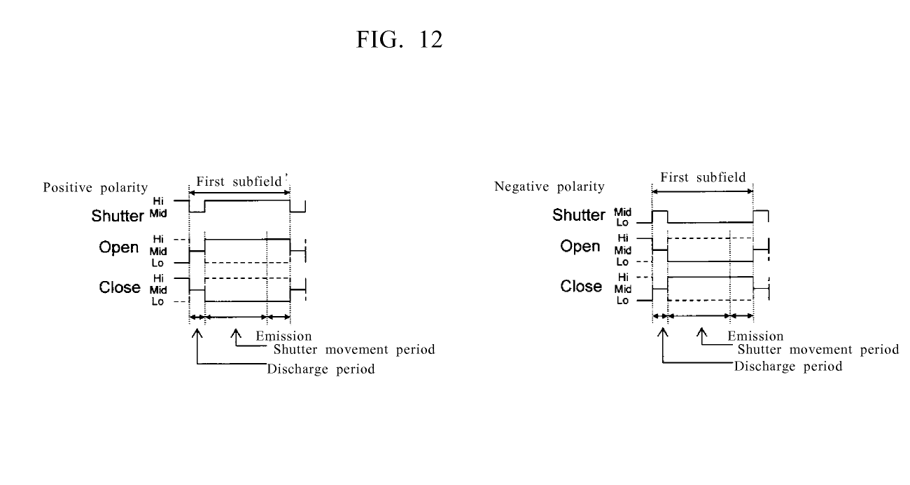

FIG. 12 is a diagram illustrating voltage changes of a shutter electrode, an OPEN electrode, and a CLOSE electrode during a discharge period, a shutter movement period, and an emission period in an image display device with a movable system according to a third embodiment of the present invention.

In a MEMS shutter (211 in FIG. 3, 309 in FIG. 7), an electric field is weakest when a voltage of all three electrodes of the shutter electrode, the OPEN electrode, and the CLOSE electrode are the same, and this state is the most electrically uniform.

Ideally, to drive the MEMS shutter (211 in FIG. 3, 309 in FIG. 7), it is favorable to arrange the voltages of the three electrodes of the shutter electrode, the OPEN electrode, and the CLOSE electrode as an H level (25 V), an L level (0 V), and an intermediate voltage (12.5 V) during the discharge period, and a method illustrated in FIG. 12 sets the voltages of the three electrodes of the shutter electrode, the OPEN electrode, and the CLOSE electrode to 12.5 V during the discharge period.

In the present embodiment, as a pixel circuit for setting the voltages of the three electrodes of the shutter electrode, the OPEN electrode, and the CLOSE electrode to 12.5 V during the discharge period, it is favorable to supply a voltage of 12.5 V to the three electrodes of the shutter electrode, the OPEN electrode, and the CLOSE electrode via a switch element that only turns on during the discharge period in the pixel circuit illustrated in FIG. 3 or 7.

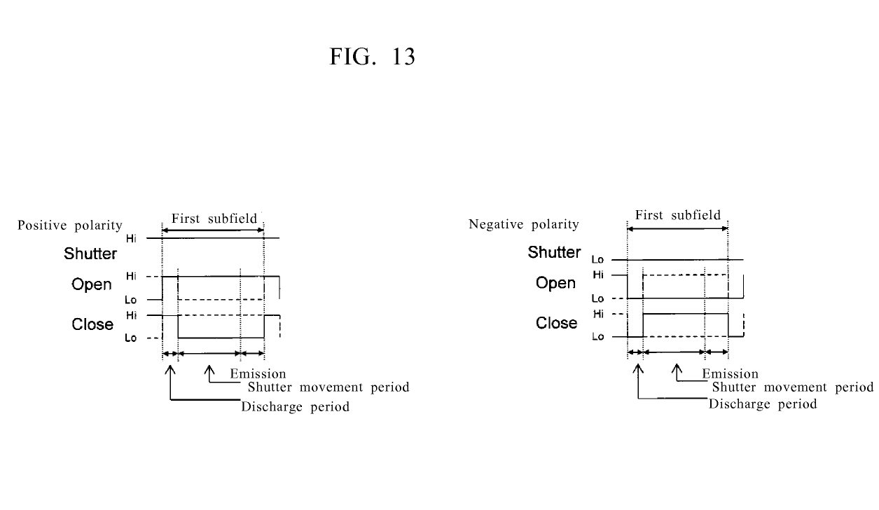

FIG. 13 is a diagram illustrating voltage changes of a shutter electrode, an OPEN electrode, and a CLOSE electrode during a discharge period, a shutter movement period, and an emission period in an image display device of a movable system according to a fourth embodiment of the present invention.

In the present embodiment, as illustrated in FIG. 13, a voltage of the OPEN electrode and a voltage of the CLOSE electrode are matched to a voltage of the shutter electrode during the discharge period.

In FIG. 13, in a state of positive polarity, the voltage of the OPEN electrode and the voltage of the CLOSE electrode are matched to the voltage of 25 V of the shutter electrode, and in a state of negative polarity, the voltage of the OPEN electrode and the voltage of the CLOSE electrode are matched to the voltage of 0 V of the shutter electrode,

In the present embodiment, too, as a pixel circuit for matching the voltage of the OPEN electrode and the voltage of the CLOSE electrode to the voltage of the shutter electrode during the discharge period, it is favorable to supply the voltage of the shutter electrode to the OPEN electrode and the CLOSE electrode via a switch element that only turns on during the discharge period in the pixel circuit illustrated in FIG. 3 or 7.

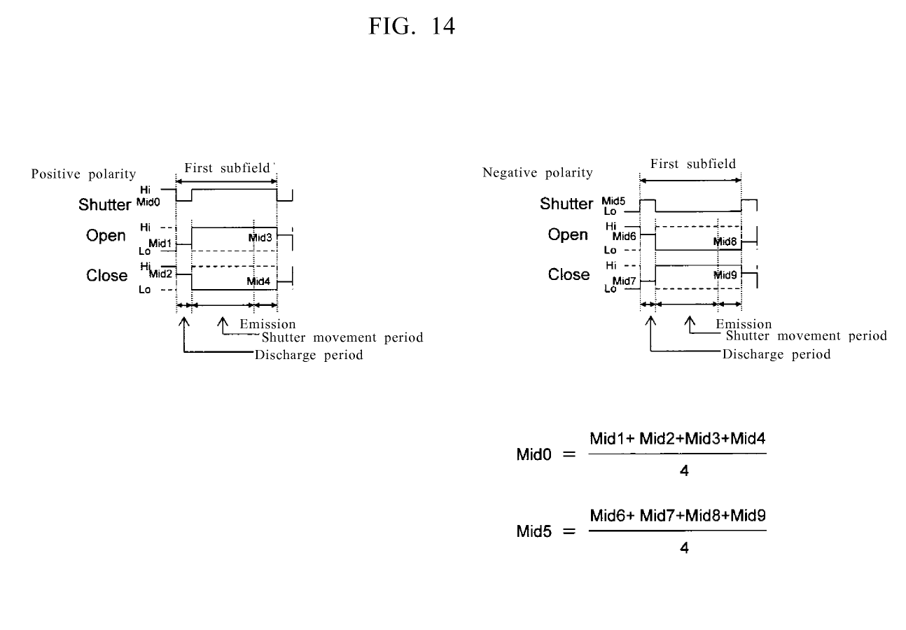

FIG. 14 is a diagram illustrating voltage changes of a shutter electrode, an OPEN electrode, and a CLOSE electrode during a discharge period, a shutter movement period, and an emission period in an image display device of a movable system according to a fifth embodiment of the present invention.

As in the first and second embodiments, there are cases where, depending on a configuration of the pixel circuit, the voltage of the OPEN electrode and the voltage of the CLOSE electrode cannot be set to any value during the discharge period. In such cases, it is favorable to set the voltage of the shutter electrode 208 to an average value of the voltage of the OPEN electrode and the voltage of the CLOSE electrode.

The present embodiment is a case where the average value of the voltage of the OPEN electrode and the voltage of the CLOSE electrode during the discharge period is the voltage of the shutter electrode during the discharge period in both the state of positive polarity and the state of negative polarity.

As illustrated in FIG. 14, in the present embodiment, in the state of positive polarity, if the voltage of the OPEN electrode during the discharge period is a voltage of Mid1 or a voltage of Mid3, and the voltage of the CLOSE electrode during the discharge period is a voltage of Mid2 or a voltage of Mid4, the voltage (Mid0) of the shutter electrode during the discharge period is set to be a voltage of a formula (1) described below.

Similarly, in the state of negative polarity, if the voltage of the OPEN electrode during the discharge period is a voltage of Mid6 or a voltage of Mid8, and the voltage of the CLOSE electrode during the discharge period is a voltage of Mid7 or a voltage of Mid9, the voltage (Mid5) of the shutter electrode during the discharge period is set to be a voltage of a formula (2) described below.

Mid0=(Mid1+Mid2+Mid3+Mid4)/4 (1)

Mid5=(Mid6+Mid7+Mid8+Mid9)/4 (2)

Here, the voltages of Mid0 and Mid5 may be 12.5 V (=25/2). Note that if the voltages of Mid1, Mid4, Mid7, and Mid9 are set to 10 V; the voltages of Mid2, Mid3, Mid6, and Mid9 are set to 15 V; and the voltages of Mid0 and Mid5 are set to 12.5 V in the formulas (1) and (2) described above, this becomes the first embodiment described above.

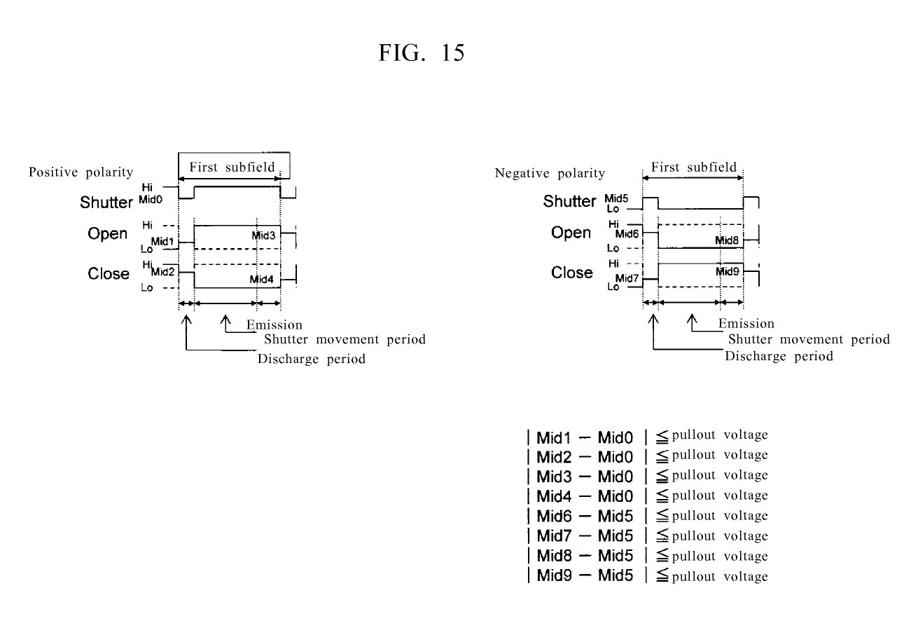

FIG. 15 is a diagram illustrating voltage changes of a shutter electrode, an OPEN electrode, and a CLOSE electrode during a discharge period, a shutter movement period, and an emission period in an image display device of a movable system according to a sixth embodiment of the present invention.

The present embodiment is a case where a voltage between the shutter electrode and the OPEN electrode and a voltage between the shutter electrode and the CLOSE electrode during the discharge period is made lower than a pull-out voltage (Vpo).

That is, as illustrated in FIG. 15, in a state of positive polarity, if the voltage of the OPEN electrode during the discharge period is a voltage of Mid1 or a voltage of Mid3, the voltage of the CLOSE electrode during the discharge period is a voltage of Mid2 or a voltage of Mid4, and the voltage of the shutter electrode during the discharge period is Mid0 (e.g., 12.5 V), a formula (3) described below is satisfied.

|Mid1−Mid0|≦Vpo

|Mid2−Mid0|≦Vpo

|Mid3−Mid0|≦Vpo

|Mid4−Mid0|≦Vpo (3)

Similarly, as illustrated in FIG. 15, in a state of negative polarity, if the voltage of the OPEN electrode during the discharge period is a voltage of Mid6 or a voltage of Mid8, the voltage of the CLOSE electrode during the discharge period is a voltage of Mid7 or a voltage of Mid9, and the voltage of the shutter electrode during the discharge period is Mid5 (e.g., 12.5 V), a formula (4) described below is satisfied.

|Mid6−Mid5|≦Vpo

|Mid7−Mid5|≦Vpo

|Mid8−Mid5|≦Vpo

|Mid9−Mid5|≦Vpo (4)

Here, the pull-out voltage (Vpo) is a voltage at a moment when the shutter electrode separates from a control electrode when an electric field is weakened from a state of pulling in the shutter electrode to the control electrode on one side.

When the electric field is weakened from the state of pulling in the shutter electrode to the control electrode on one side, a rapid relaxation of the electric field is generated at the moment when the shutter electrode separates from the pulling electrode, and an effect of discharge is obtained if this is at least lower than this voltage.

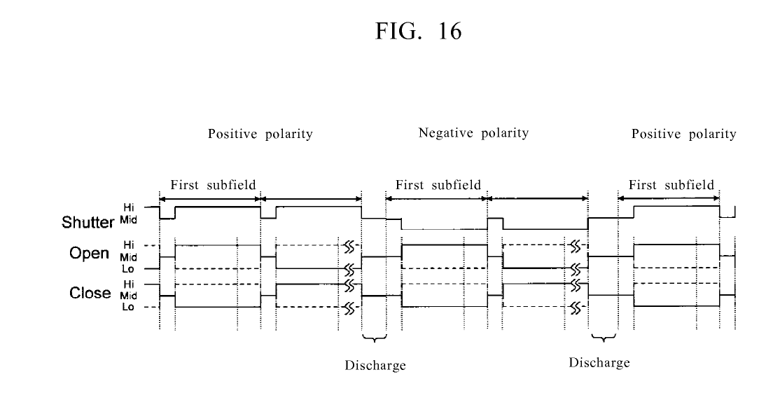

FIG. 16 is a diagram illustrating voltage changes of a shutter electrode, an OPEN electrode, and a CLOSE electrode during a discharge period, a shutter movement period, and an emission period in an image display device with a movable shutter system according to a seventh embodiment of the present invention.

The present embodiment inserts the discharge period between subfields at a time of polarity reversal from a state of positive polarity to a state of negative polarity or from the state of negative polarity to the state of positive polarity.

An electric charge is fed to an insulating film in a direction in which the electric field weakens if the same electric field continues to be applied. Moreover, the electric charge fed at this time changes to a direction that strengthens the electric field when the polarity is reversed. Therefore, the greatest electric field is applied to the insulating film at the moment of polarity reversal. The greatest electric field described above can be avoided by reversing the polarity in a state of discharge.

The invention made by the present inventor is specifically described above based on the embodiments described above, but the present invention is not limited to the embodiments, and it is a matter of course that various modifications are possible without departing from the scope and the spirit thereof.

### EXPLANATION OF REFERENCE NUMERALS

1 Display panel

2 Backlight

3 Display panel control device

4 Backlight control device

5 System controller

6 Frame memory

11 Pixel

12 Scanning line

13 Video line

14 Video line drive circuit

15 Scanning line drive circuit

16 Wiring

21, 23 Reflective film

22 Light guide plate

24 Black film

30, 32 polycrystalline silicon thin film doped with high-concentration n-type impurities

31 Polycrystalline silicon thin film

33 Gate insulating film

34 Insulating protective film

35 Gate electrode

36, 40 Drain electrode

37 Source

38 Protective film

39 Glass substrate

50 insulating film

200, 300 Scanning switch

202, 204, 206 pMOS transistor

201, 203, 205, 301, 302 NMOS transistor

207, 303 Signal storage capacitor

209, 210, 307, 308 Control electrode

208, 306 Shutter electrode

211, 309 MEMS shutter

Hgh Positive voltage line

Low Negative voltage line

Upd Update line

Sht Shutter voltage line

Cap Capacity control voltage line

Com Common power supply line

What is claimed is:

1. A display device, comprising:
a plurality of pixels each having a mechanical shutter wherein
the mechanical shutter comprises a shutter electrode and first and second control electrodes provided in a pair with respect to the shutter electrode; and
the display device displays images by electrically controlling a position of the shutter electrode; wherein the display device is provided with
a discharge period and a display period after the discharge period, and
during the discharge period Vp1=Vp2=Vs, where
Vs is a voltage supplied to the shutter electrode, Vp1 is a voltage supplied to the first control electrode, and Vp2 is a voltage supplied to the second control electrode.

2. The display device according to claim 1, wherein
during the display period, a low voltage drive voltage of VL, or a high voltage drive voltage of VH with a voltage higher than the low voltage drive voltage of VL, is supplied to the shutter electrode, the first control electrode, and the second control electrode, and
Vs=(VH−VL)/2.

3. The display device according to claim 1, wherein
during the display period, a low voltage drive voltage of VL, or a high voltage drive voltage of VH with a voltage higher than the low voltage drive voltage of VL, is supplied to the shutter electrode, the first control electrode, and the second control electrode, and
Vs=VH.

4. The display device according to claim 1, wherein
during the display period, a low voltage drive voltage of VL, or a high voltage drive voltage of VH with a voltage higher than the low voltage drive voltage of VL, is supplied to the shutter electrode, the first control electrode, and the second control electrode, and
Vs=VL.

5. A display device, comprising:
a plurality of pixels each having a mechanical shutter, wherein the mechanical shutter comprises a shutter electrode and first and second control electrodes provided in a pair with respect to the shutter electrode; and
the display device displays images by electrically controlling a position of the shutter electrode; wherein the display device is provided with
a discharge period and a display period after the discharge period, and
in the display period, a low voltage drive voltage of VL, or a high voltage drive voltage of VH with a voltage higher than the low voltage drive voltage of VL, is supplied to the shutter electrode, the first control electrode, and the second control electrode, and during the discharge period

|Vs−Vp1|≦(VH−VL)/10, and

|Vs−Vp2|≦(VH−VL)/10, where
Vs is a voltage supplied to the shutter electrode, Vp1 is a voltage supplied to the first control electrode, and Vp2 is a voltage supplied to the second control electrode.

6. The display device according to claim 5, wherein Vs is equal to (VH+VL)/2.

7. A display device, comprising:
a plurality of pixels each having a mechanical shutter, wherein
the mechanical shutter comprises a shutter electrode and first and second control electrodes provided in a pair with respect to the shutter electrode; and
the display device displays images by electrically controlling a position of the shutter electrode; wherein the display device is provided with
a discharge period and a display period after the discharge period, and
during the discharge period, when a voltage Vs is supplied to the shutter electrode, an average value of the voltage supplied to the first control electrode and an average value of the voltage supplied to the second control electrode are the same voltage as Vs.

8. A display device, comprising:
a plurality of pixels each having a mechanical shutter, wherein
the mechanical shutter comprises a shutter electrode and first and second control electrodes provided in a pair with respect to the shutter electrode; and
the display device displays images by electrically controlling a position of the shutter electrode; wherein the display device is provided with
a discharge period and a display period after the discharge period, and during the discharge period
(Vp1+Vp2)/2=Vs, where
Vs is a voltage supplied to the shutter electrode, Vp1 is a voltage supplied to the first control electrode, and Vp2 is a voltage supplied to the second control electrode.

9. A display device, comprising:
a plurality of pixels each having a mechanical shutter, wherein
the mechanical shutter comprises a shutter electrode and first and second control electrodes provided in a pair with respect to the shutter electrode; and
the display device displays images by electrically controlling a position of the shutter electrode; wherein the display device is provided with
a discharge period and a display period after the discharge period, and during the discharge period

|Vs−Vp1|≦Vpo, and

|Vs−Vp2|≦Vpo, where
Vs is a voltage supplied to the shutter electrode, Vp1 is a voltage supplied to the first control electrode, Vp2 is a voltage supplied to the second control electrode, and Vpo is a pull-out voltage.

10. The display device according to any one of claims 7 to 9, wherein
during the display period, a low voltage drive voltage of VL, or a high voltage drive voltage of VH with a voltage higher than the low voltage drive voltage of VL, is supplied to the shutter electrode, the first control electrode, and the second control electrode, and
Vs is a voltage equal to (VH+VL)/2.

11. The display device according to any one of claims 5 to 10, further comprising:
a plurality of video lines that input an image signal voltage to each pixel;
a plurality of scanning lines that input a scanning voltage to each pixel;
a first power supply line that supplies a first power supply voltage;
a second power supply line that supplies a second power supply voltage;
a shutter voltage line that supplies a shutter control voltage; and
an update voltage line that supplies an update voltage; wherein
each pixel has a pixel circuit that electrically controls a position of the mechanical shutter;
the pixel circuit comprises an input transistor where current source is connected to a corresponding video line from among the plurality of video lines, and a gate is connected to a corresponding scanning line from among the plurality of scanning lines;
a storage capacitor that stores voltage output by the input transistor and has another end connected to the first power supply line while one end is connected to a drain of the input transistor;
a transfer transistor where a gate is connected to the update voltage line and a source is connected to the drain of the input transistor;
a first CMOS inverter circuit connected between the first power supply line and the second power supply line with the input terminal thereof connected to a drain of the transfer transistor;
a second CMOS inverter circuit connected between the first power supply line and the second power supply line with the input terminal thereof connected to an output terminal of the first CMOS inverter circuit; and
a first transistor connected between the input terminal of the first CMOS inverter circuit and an output terminal of the second inverter circuit and a gate is connected to the update voltage line; and
the first control electrode is connected to the output terminal of the first CMOS inverter circuit;
the second control electrode is connected to the output terminal of the second CMOS inverter circuit; and
the shutter electrode is connected to the shutter voltage line.

12. A display device, comprising:
a plurality of pixels each having a mechanical shutter, wherein
the mechanical shutter comprises a shutter electrode and first and second control electrodes provided in a pair with respect to the shutter electrode; and
the display device displays images by electrically controlling a position of the shutter electrode; wherein
each pixel has a pixel circuit that electrically controls a position of the mechanical shutter;
the pixel circuit comprises a first drive transistor that supplies drive voltage to the first control electrode;
a second drive transistor that supplies drive voltage to the second control electrode;
wherein the display device is provided with a discharge period and a display period after the discharge period; and
during the display period, a low voltage drive voltage of VL, or a high voltage drive voltage of VH with a voltage higher than the low voltage drive voltage of VL, is supplied to the shutter electrode, and during the discharge period
Vs=VH,

|Vs−Vp1|≦Vth, and

|Vs−Vp2|≦2Vth, where
Vs is a voltage supplied to the shutter electrode, Vp1 is a voltage supplied to the first control electrode, Vp2 is a voltage supplied to the second control electrode, and Vth is a threshold voltage of the first drive transistor and the second drive transistor.

13. A display device, comprising:
a plurality of pixels each having a mechanical shutter, wherein
the mechanical shutter comprises a shutter electrode and first and second control electrodes provided in a pair with respect to the shutter electrode; and
the display device displays images by electrically controlling a position of the shutter electrode, wherein
each pixel has a pixel circuit that electrically controls a position of the mechanical shutter;
the pixel circuit comprises a first drive transistor that supplies drive voltage to the first control electrode;
a second drive transistor that supplies drive voltage to the second control electrode;
wherein the display device is provided with a discharge period and a display period after the discharge period, and
during the display period, a low voltage drive voltage of VL, or a high voltage drive voltage of VH with a voltage higher than the low voltage drive voltage of VL, is supplied to the shutter electrode, and during the discharge period
Vs=VH−Vth,

|Vs−Vp1|≦Vth, and

|Vs−Vp2|≦Vth, where
Vs is a voltage supplied to the shutter electrode, Vp1 is a voltage supplied to the first control electrode, Vp2 is a voltage supplied to the second control electrode, and Vth is a threshold voltage of the first drive transistor and the second drive transistor.

14. The display device according to claim 12 or 13, comprising:
a plurality of video lines that input an image signal voltage to each pixel;
a plurality of scanning lines that input a scanning voltage to each pixel;
a power supply line that supplies common power supply voltage;
a capacitor control voltage line the supplies a capacitor control voltage;
a shutter voltage line that supplies shutter control voltage; and
an update voltage line that supplies an update voltage; wherein
the pixel circuit comprises an input transistor where a source is connected to a corresponding video line from among the plurality of video lines, and a gate is connected to a corresponding scanning line from among the plurality of scanning lines;
a storage capacitor that stores voltage output by the input transistor and has another end connected to the capacitor control voltage line while one end is connected to a drain of the input transistor;
a first capacitor connected between the first drive transistor and the power supply line; and
a second capacitor connected between the second drive transistor and the power supply line; and
with the first drive transistor, a gate is connected to the drain of the input transistor while a source is connected to the update voltage line, and a drain is connected to one end of the first capacitor; and
with the second drive transistor, a gate is connected to the drain of the first drive transistor while a source is connected to the update voltage line, and a drain is connected to one end of the second capacitor; and
the first control electrode is connected to the drain of the first drive transistor; and
the second control electrode is connected to the drain of the second drive transistor; and
the shutter electrode is connected to the shutter voltage line.

15. The display device according to any one of claims 1 to 14, wherein
a subfield has a negative polarity drive state in the display period that applies the low voltage drive voltage of VL to the shutter electrode,
a positive polarity drive state in the display period that applies the high voltage drive voltage of VH with a voltage higher than the low voltage drive voltage of VL to the shutter electrode, and
the discharge period occurs between switching from the negative polarity drive state to the positive polarity drive state, or when switching from the positive polarity drive state to the negative polarity drive state.
